(19) United States
(12) Patent Application Publication
(10) Pub. No.: US 2018/0206671 A1
(43) Pub. Date: Jul. 26, 2018

(54) LIQUID COOLING DEVICE AND BEVERAGE FORMING DEVICE

(71) Applicant: Sharp Kabushiki Kaisha, Sakai City, Osaka (JP)

(72) Inventors: Masaaki KODAMA, Sakai City (JP); Toshinori OKADA, Sakai City (JP); Daisuke TAKAHASHI, Sakai City (JP); Motoyasu YOSHII, Sakai City (JP); Hitoshi KIJI, Sakai City (JP); Jun GOTO, Sakai City (JP); Shinji NAGAI, Sakai City (JP); Daiki ENDO, Sakai City (JP); Norio KANETSUKI, Sakai City (JP); Yukari MORIOKA, Sakai City (JP)

(21) Appl. No.: 15/746,004

(22) PCT Filed: Jul. 22, 2016
(86) PCT No.: PCT/JP2016/071506

§ 371 Date: Jan. 19, 2018

(30) Foreign Application Priority Data
Jul. 24, 2015 (JP) 2015-147237

(51) Int. Cl. A47J 31/50; A23L 33/00; F25D 31/00

(52) U.S. Cl. CPC A47J 31/50; A23V 2002/00; F25D 31/002; A23L 33/40

(57) ABSTRACT

A liquid cooling device that is capable of efficiently cooling a liquid in the inside of a liquid holding container, and a beverage forming device including the liquid cooling device are provided.

The liquid cooling device includes the liquid holding container that has an open portion; a container mounting part on which the liquid holding container is to be mounted; an air passage; and an airflow generating unit. The air passage is located directly above the open portion (4b), and at least a part of an outer periphery of the air passage extends along a peripheral edge of the open portion (4b). The airflow generating unit generates, within the air passage, an airflow flowing along the air passage. A hole portion (33) that communicates with the open portion (4b) is provided in a lower surface of the air passage.

### TECHNICAL FIELD

The present invention relates to a liquid cooling device and a beverage forming device including the liquid cooling device.

### BACKGROUND ART

In recent years, WHO (World Health Organization) and FAO (Food and Agriculture Organization of the United Nations) have jointly prepared “Guideline for the Safe Preparation, Storage and Handling of Dry Powdered Infant Formula”.

This guideline reports the relationship between dry powdered infant formula, that is, powdered infant milk and serious illnesses and deaths of infants caused by, for example, Enterobacter sakazakii infection.

It is reported that, as a preventive measure against the infection, the dry powdered formula that is given to infants must be prepared by using boiled water at a temperature of 70° C. or greater. As a specific method of preparing milk, the following method is described in the guideline.

(1) Clean and disinfect a surface where a dry powdered formula (powdered milk) is prepared.

(2) Wash your fingers with soap and clean water, and wipe off any moisture by using a clean cloth or disposable napkin.

(3) Boil a sufficient amount of safe water.

(4) Taking care to avoid scalds, pour the correct amount of boiled water that has been cooled to 70° C. or greater into a cleaned and sterilized cup or feeding bottle.

(5) Add the exact amount of dry powdered formula that is indicated.

(6) In a short time, cool to a suitable feed temperature by placing under running tap water, or by placing in a container of cold water or iced water.

(7) Wipe the outside of the feeding cup or the feeding bottle with a clean cloth or a disposable cloth, and indicate the necessary information, such as the type of dry powdered formula, the name or identification number of the infant, the date and time when the formula was prepared, or the name of the staff member who prepared the formula.

(8) Since water of a very high temperature is used to prepare the milk, check the feed temperature before feeding while taking care to avoid scalding the mouth of the infant.

(9) Throw away all dry powdered formula that has not been consumed within two hours after the preparation of the powdered formula.

Here, a suitable temperature of milk that is given to infants is about 40° C., which is skin temperature, considering, for example, the temperature of mother's milk and body temperature. Therefore, in order to prepare the dry powdered formula into milk to be given to an infant, it is necessary to, after preparing the milk by using a liquid that is boiled to a temperature of 70° C. or greater once, cool the milk to a temperature of about 40° C.

As an existing device and method for preparing infant milk, for example, the technologies disclosed in Patent Literature 1 and Patent Literature 2 are known.

A milk-preparing-pot heating device 100 disclosed in Patent Literature 1 is a device for preparing hot water for preparing milk. As shown in FIGS. 16(A) and 16(B), the milk-preparing-pot heating device 100 includes a case 101 and a heating plate 102 on which a milk preparing pot 120 is placed in the case 101. The heating plate 102 is supported by a cooling fan 103 provided in the case 101, and is surrounded by a heat-resistant cover 101a, which is an inner wall of the case. An air path 110 is formed between the heating plate 102 and the heat-resistant cover 101a. When the milk preparing pot 120 is placed on the heating plate 102, and is heated by the heating plate 102, boiled water is generated from water in the milk preparing pot 120. The cooling fan 103 is rotated, and the milk preparing pot 120 is cooled by air that flows in from air inlets 104.

Next, a milk preparing device that is disclosed in Patent Literature 2 prepares a concentrate where a formula of an amount required for the total amount of mixture is mixed by using warm water of a certain amount. Then, in order to reach a final volume of the mixture with respect to the concentrate, a liquid of a low temperature is added to perform adjustments to provide milk of a suitable temperature.

### CITATION LIST

### Patent Literature

PTL 1: Japanese Unexamined Patent Application Publication No. 2005-110937

PTL 2: Japanese Unexamined Patent Application Publication No. 2010-524550

### SUMMARY OF INVENTION

### Technical Problem

However, the liquid cooling mechanisms of the above-described existing beverage forming devices have the following problems.

First, in the milk-preparing-pot heating device 100 disclosed in PTL 1, by rotating the cooling fan 103 in the inside of the case 101, air that flows in from the air inlets 104 passes in the air path 110 and cools an outer wall of the milk preparing pot 120. Therefore, in a heat-dissipation path of hot water in the inside of the milk preparing pot 120, only heat transfer to the outer wall of the milk preparing pot 120 occurs, and it takes time to perform the cooling. In addition, the milk-preparing-pot heating device 100 has as its purpose cooling boiled water to 55° C., and is not fit for cooling milk that has been prepared at 70° C. or higher down to 40° C. at which the milk is suitable for drinking.

In the milk-preparing-pot heating device 100 disclosed in PTL 1, since the outer wall of the milk preparing pot 120 is cooled by air, the water is indirectly cooled through the outer wall. Therefore, since the thermal conductivity of the milk preparing pot 120, itself, is poor, it is difficult to perform effective cooling.

Next, in the milk preparing device disclosed in PTL 2, although the operations from preparing the milk to cooling the milk can be automatically performed, it is necessary to dilute the concentrate. Therefore, in order to cool the milk, a stirring/mixing step for mixing warm water and cooling water is required. However, in order to prevent unmelted dry powdered formula from remaining, it is necessary to prepare the concentrate by using a large amount of high-temperature water. Therefore, in order to adjust the temperature and amount of prepared milk to a certain temperature and a certain amount, it is necessary to use cooling water whose temperature is less than or equal to normal temperature. Consequently, a cooling device must be provided in the milk preparing device. In order to reduce the temperature of the cooling water by the cooling device and maintain its temperature to a certain temperature, a long time is required to make it possible to start preparing the milk from when a power supply is turned on. In addition, there are problems from the viewpoint of costs due to, for example, the necessity of providing the cooling device and a sterilizer for the cooling water. Further, for example, from the viewpoint of adding and mixing the cooling water, the method of preparing milk differs from a safe method of preparing milk based on the “Guideline for the Safe Preparation, Storage and Handling of Dry Powdered Infant Formula”. In addition, even in the milk preparing device disclosed in PTL 2, since, in order to cool the milk, the stirring/mixing step for mixing the warm water and cooling water is required, it is difficult to perform efficient cooling.

Accordingly, it is an object of the present invention to provide a liquid cooling device that is capable of efficiently cooling a liquid, and a beverage forming device including the liquid cooling device.

### Solution to Problem

A liquid cooling device according to the present invention includes a liquid holding container that has an open portion; a container mounting part on which the liquid holding container is to be mounted; an air passage; and an airflow generating unit. The air passage is located directly above the open portion, and at least a part of an outer periphery of the air passage extends along a peripheral edge of the open portion. The airflow generating unit generates, within the air passage, an airflow flowing along the air passage. A hole portion that communicates with the open portion is provided in a lower surface of the air passage.

### Advantageous Effects of Invention

According to a form of the present invention, it is possible to efficiently cool a liquid.

### BRIEF DESCRIPTION OF DRAWINGS

FIG. 1 is a sectional view of a liquid cooling device according to a first embodiment of the present invention and a structure of a powdered-milk preparing device including the liquid cooling device.

FIG. 2(A) is a perspective view of the liquid cooling device according to the first embodiment of the present invention, FIG. 2(B) is a side sectional view, and FIG. 2(C) is a top view.

FIG. 3(A) is a sectional view of a state of a liquid surface in the inside of a milk preparing pot with a stirrer of the milk preparing pot in the liquid cooling device in a stopped state, and FIG. 3(B) is a sectional view of a state of the liquid surface in the inside of the milk preparing pot with the stirrer in a rotating state.

FIG. 4(A) is a sectional view of a state of heat dissipation and defoaming in the inside of the milk preparing pot with the stirrer of the milk preparing pot in the liquid cooling device in a rotating state, and of a mixed state with a rotation direction of the stirrer and a direction of airflow that is generated in the inside of the milk preparing pot opposing each other, and FIG. 4(B) is a sectional view of a state in which the rotation direction of the stirrer and the direction of airflow that is generated in the inside of the milk preparing pot are the same.

FIG. 5 is a top view of a liquid cooling device according to a second embodiment of the present invention.

FIG. 6(A) is a top view of a liquid cooling device according to a third embodiment of the present invention, and FIG. 6(B) is a sectional view along arrow A-A in FIG. 6(A).

FIG. 7(A) is a perspective view of a liquid cooling device according to a fourth embodiment of the present invention, and FIG. 7(B) is a top view.

FIG. 8(A) is a top view of a liquid cooling device according to a fifth embodiment of the present invention, and FIG. 8(B) is a schematic sectional view for describing a guide portion.

FIG. 9 is a top view of a liquid cooling device according to a sixth embodiment of the present invention.

FIG. 10 is a schematic sectional view of a guide portion according to a seventh embodiment of the present invention.

FIG. 11 is a schematic sectional view of a guide portion according to an eighth embodiment of the present invention.

FIG. 12 is a schematic sectional view of a guide portion according to another embodiment of the present invention.

FIG. 13 is a schematic sectional view of a guide portion according to still another embodiment of the present invention.

FIGS. 14(A) and 14(B) are sectional views of a structure of an existing beverage forming device and a cooling mechanism.

### DESCRIPTION OF EMBODIMENTS

### First Embodiment

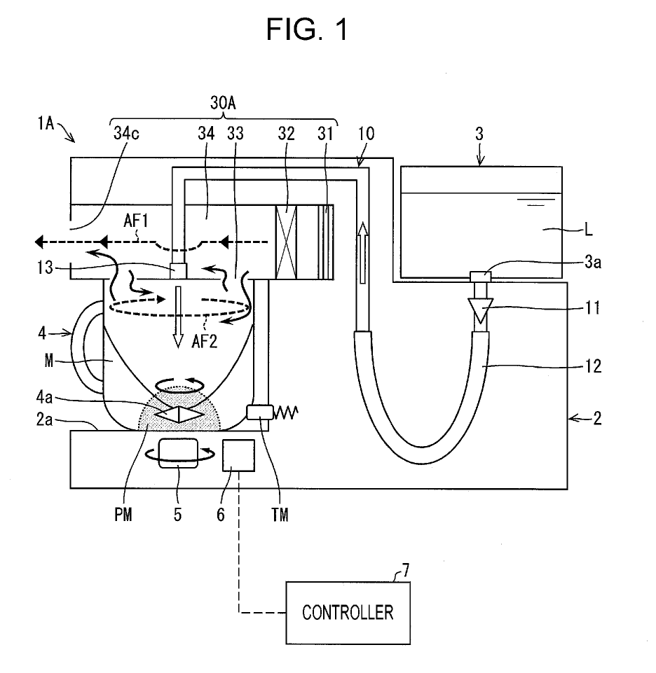

Embodiments of the present invention are described in detail below. An embodiment of the present invention is described on the basis of FIGS. 1 to 4 and the description thereof is as follows.

In the embodiment, for example, a powdered formula preparing device (beverage forming device) that makes milk as a beverage by automatically mixing powdered infant milk, serving as a mixture extraction raw material, and a heated liquid, and a liquid cooling device of the powdered formula preparing device are described. In the embodiment, the powdered formula preparing device is given and described as an example of the beverage forming device. However, the beverage forming device of the present invention is not necessarily limited thereto. For example, the beverage forming device is applicable to a coffee maker, serving as a beverage forming device, which automatically makes coffee, serving as a mixture, forming by pouring a heated liquid onto ground coffee beams, serving as a mixture extraction raw material. Alternatively, the beverage forming device is applicable to a tea maker, serving as a beverage forming device, which automatically makes Japanese green tea or tea, serving as a mixture, formed by pouring a heated liquid onto tea leaves, serving as a mixture extraction raw material. The liquid cooling device of the present invention is applicable to a cooling portion that cools coffee for the coffee maker or Japanese green tea or tea for the tea maker. The liquid cooling device of the present invention is capable of quickly cooling a liquid while reducing the entry of foreign substances, such as dust, and is applicable to, for example, cooling of a beverage or cooling in a food manufacturing step or a chemical process.

### (Structure of Powdered Formula Preparing Device 1A)

First, a structure of a powdered formula preparing device (beverage forming device) 1A is described on the basis of FIG. 1.

As shown in FIG. 1, the powdered formula preparing device 1A according to the embodiment includes a device body 2 that serves as a housing, a container 3 that stores a liquid L, and a milk preparing pot 4 that serves as a mixture preparing portion.

The container 3 is disposed on an upper portion of the device body 2, and is removable from the device body 2. The container 3 stores the liquid L used for preparing milk. Examples of the liquid L include, in addition to tap water, drinking water for a baby, pure water or natural water, and other types of water suitable for drinking by a baby. A feed valve 3a is provided at a lower portion of the container 3. The feed valve 3a closes when the container 3 is removed from the device body 2. Therefore, the container 3 can be removed from the device body 2 and can be supplied with water from a tap, and can be carried after supplying the water. Thereafter, when the container 3 is mounted on the device body 2, the feed valve 3a opens, and the liquid L is supplied to a supply pipe 10 and a heater 12.

Here, a side surface of the container 3 is provided with a scale that allows the water quantity to be known. A user can adjust the milk preparation amount by using the scale. The scale may be provided on an inner side surface of the container 3, or the container 3 may be made transparent to allow the water quantity to be confirmed from the outside.

The container 3 may be provided with, for example, a filter (not shown) to allow constituents of, for example, ion-based metals, bacteria or germs, and impurities or chlorine in the poured liquid L to be removed. The filter is made of, for example, activated carbon or an ion exchange membrane. Further, assuming that the liquid L is stored for a long time, for example, a sterilizer, such as an ultraviolet irradiation device, may be mounted on an upper portion of the container 3. This makes it possible to sterilize the stored liquid L by irradiating the liquid L with ultraviolet light.

The device body 2 includes a placement portion 2a on which the milk preparing pot 4 is placed. The user makes milk M at the milk preparing pot 4. The milk M is a prepared mixture of hot water and powdered milk PM, which is a beverage ingredient. A stirrer 4a for mixing the liquid L and the powdered milk PM is provided in the inside of the milk preparing pot 4.

An operation panel 6 for allowing a user to operate the powdered formula preparing device 1A is provided below the milk preparing pot 4 at the device body 2. The operation panel 6 is connected to a controller 7 that controls the operation of each portion of the device body 2.

The supply pipe 10, the heater 12 that heats the liquid L supplied by the supply pipe 10, a hot water supply inlet 13 for supplying the liquid L heated by the heater 12 into the milk preparing pot 4, a motor 5 for rotating the stirrer 4a in the inside of the milk preparing pot 4, and a thermistor TM that measures the temperature of the milk M in the inside of the milk preparing pot 4 are provided in the inside of the device body 2. The supply pipe 10 is provided with a float-type check valve 11 that prevents reverse flow of the liquid L into the container 3. A cooling portion 30A that cools the milk M that is made in the inside of the milk preparing pot 4 is installed in the device body 2. Therefore, from the container 3 to an inner portion of the supply pipe 10, the liquid L stored in the container 3 flows into an entrance of the heater 12 via the float-type check valve 11, and flows out from an exit of the heater 12 to the hot water supply inlet 13 via the cooling portion 30A.

The supply pipe 10 may be, for example, a metal pipe, such as a stainless steel (SUS) pipe, or a resin pipe, such as a silicon-based resin pipe or a Teflon (tradename) based resin pipe. As the material of the supply pipe 10, it is desirable to select, for example, a silicon-based member suitable for supply in food use. In the embodiment, as the supply pipe 10, for example, a silicon tube having an inside diameter of ϕ10 mm is used. The material of the tube and the size, such as the inside diameter, of the tube may be arbitrarily set. In the powdered formula preparing device 1A, the method of connecting the supply pipe 10 and each part may be any fixing method that is suitable for, for example, the size of the supply pipe 10.

The float-type check valve 11 has a function of preventing reverse flow of the liquid L from the heater 12 to the container 3, and a function of stopping the supply of the liquid L at a water level of the float-type check valve 11.

In the embodiment, as shown in FIG. 1, the heater 12 has the form of, for example, a U-shaped pipe, and is formed so as to cover a part of the supply pipe 10 from a surrounding portion. The heater 12 has, for example, a nichrome wire installed therein, and has a function of heating, boiling, and sterilizing the liquid L for making milk, and supplying the liquid L to the hot water supply inlet 13. More specifically, the function is as described in (1) to (5) below.

(1) The liquid L from the container 3 passes through the float-type check valve 11, and flows into a U-shaped portion of the supply pipe 10 that is covered by the heater 12.

(2) The liquid L that has flown into the U-shaped portion of the supply pipe 10 that is covered by the heater 12 fills a portion up to a height where the float-type check valve 11 is mounted.

(3) When heating is started by the heater 12, the liquid L is boiled and is pushed up from the heater 12 by vapor pressure.

(4) Since the float-type check valve 11 is provided at an entrance side of the heater 12, the liquid L is pushed out from only the exit of the heater 12 on the opposite side, and is supplied to the hot water supply inlet 13 via the supply pipe 10.

(5) The liquid L in the inside of the portion of the supply pipe 10 that is covered by the heater 12 is reduced in amount, so that the pressure in the inside of the portion of the supply pipe 10 that is covered by the heater 12 is reduced, and the float-type check valve 11 opens. As a result, the process returns to (1), and the liquid L before heating flows in.

The heater 12 of the embodiment is provided with a temperature sensor (not shown) mounted thereat, so that the heating temperature of the heater 12 can always be measured.

(1) to (5) above are repeated until the container 3 runs out of the liquid L, and the liquid L that has been heated by the heater 12 is pressure-fed to the hot water supply inlet 13. When the inside of the supply pipe 10 runs out of the liquid L, it becomes difficult to transmit the heat from the heater 12 to the outside, and the temperature of the heater 12, itself, tends to rise to a temperature greater than or equal to the boiling temperature of the liquid L. As a result, by setting and detecting this temperature, which is the upper limit, the heating by the heater 12 can be stopped.

The liquid L may be pressure-fed to a sprinkler nozzle and a funnel (not shown) from the heater 12. By causing the liquid L to be jetted to the funnel from the sprinkler nozzle, it is possible to reduce the temperature of the liquid L. In this case, the hot water supply inlet 13 is provided at a lower portion of the funnel, and the liquid L falls in drops into the milk preparing pot 4 from the hot water supply inlet 13.

Below the hot water supply inlet 13, the milk preparing pot 4 is placed on the placement portion 2a of the device body 2. The milk preparing pot 4 is one in which the milk M is made by preparing and mixing the dry powdered formula, that is, the powdered milk PM, which has been previously set inside the milk preparing pot 4, and the boiled liquid L for making the milk.

In the embodiment, the stirrer 4a for stirring and mixing the powdered milk PM and the liquid L is provided in the inside of the milk preparing pot 4.

A magnet is disposed in the inside of the stirrer 4a. The surface of the magnet is covered with resin. The resin that covers the surface of the magnet is desirably resin suitable for food. As the material, it is desirable to use, for example, a material that is the same as that of the aforementioned supply pipe 10, such as silicon-based resin or Teflon (trade name) based resin, or polypropylene.

The stirrer 4a may have various shapes, such as an elongated cocoon shape, an octagonal rod shape, a disc shape, and a vane shape of a windmill. In the embodiment, the stirrer 4a has a disc shape of ϕ70 mm to ϕ80 mm.

The magnet in the inside of the stirrer 4a forms a pair with a magnet (not shown) disposed at a rotary shaft of the motor 5 that is disposed in the inside of the device body 2 below the milk preparing pot 4. Therefore, the stirrer 4a rotates in correspondence with the operation of the motor 5.

As mentioned above, the motor 5 is provided with the magnet, and the magnet rotates due to the rotation of the motor 5. Due to the rotation of the magnet, the stirrer 4a rotates. That is, the motor 5 has a function of rotating the stirrer 4a. Therefore, the stirrer 4a and the motor 5 function as a rotating mechanism that rotates and mixes the liquid L and the powdered milk PM.

In the embodiment, the motor 5 is controlled independently of the operation of causing the liquid L to fall in drops into the milk preparing pot 4 in the operation of the powdered formula preparing device 1A. That is, when the liquid L falls in drops, the motor 5 may be operating or may be stopped. In addition, the rotation direction and the rotation speed of the motor 5 are variable, and, as mentioned later, are controlled at appropriate times by the controller 7 when the milk M is being made. Therefore, the rotation direction and the rotation speed of the stirrer 4a are controlled by controlling the motor 5.

Here, it is desirable that an electric current detecting circuit be provided in a power supply system for supplying power to the motor 5. When the milk M is made without mounting the stirrer 4a, or when the stirrer 4a is positionally displaced from the magnet of the motor 5 due to some abnormality, the load on the motor 5 is reduced. By detecting the reduction in the load by using the electric current detecting circuit, it is possible to detect any abnormality in the operation of the powdered formula preparing device 1A.

The cooling portion 30A includes an air inlet portion 31, a blowing fan 32, and a blowing channel 34 having hole portions 33, and functions as a temperature adjusting portion that cools the milk M after the mixing. The blowing channel 34 has a downstream-side outlet 34c. The structure of the cooling portion 30A is described in detail later.

The thermistor TM indirectly measures the temperature of the liquid L or the milk M in the inside of the milk preparing pot 4. By previously measuring the temperature of the milk M in the inside of the milk preparing pot 4 and the measured temperature at the thermistor TM, a user can set the temperature of the milk that is ready. It is determined that the preparation of the milk is completed on the basis of the temperature detected at the thermistor TM, and the user is notified that the milk is ready by means of sound or a lamp.

The quantity of the milk M can be predicted on the basis of the change in the temperature of the milk M in the inside of the milk preparing pot 4. Therefore, it is possible to set the rotation speed of the stirrer 4a such that a contact area between the milk M and an inner surface of the milk preparing pot 4 and the surface area of the milk M are made as large as possible.

Here, the thermistor TM measures the temperature of the liquid L or the temperature of the milk M in the inside on the basis of the temperature of an outer surface of the milk preparing pot 4. Therefore, in order to reliably transmit heat between the thermistor TM and the milk preparing pot 4, the thermistor TM contacts the milk preparing pot 4 by being pushed against the milk preparing pot 4 by, for example, a spring. Further, in order to make constant the positional relationship between the milk preparing pot 4 and the device body 2, it is desirable to provide a positioning pin or a guide.

The milk M that is ready is transferred to a feeding bottle and given to the baby. Therefore, when the user is to be notified that the milk M is ready by means of sound or a lamp, it is desirable to perform setting such that detection is made at a temperature higher than 40° C., which is a reference feed temperature, or about 45° C. as a reference temperature.

In such powdered formula preparing device 1A, serving as such a beverage forming device, the liquid L and the powdered milk PM required for preparing a desired amount of milk M are weighed for the container 3 and the milk preparing pot 4, respectively, and the powdered formula preparing device 1A is operated, so that the milk M can be automatically prepared.

### (Structure of Liquid Cooling Device 10A)

Here, a structure of a liquid cooling device 10A of the powdered formula preparing device 1A of the embodiment is described.

Here, the term “liquid cooling device 10A” refers to a structure including at least the placement portion 2a on which the milk preparing pot 4 is placed and the cooling portion 30A. The liquid cooling device 10A may have a structure including the milk preparing pot 4 in accordance with its use.

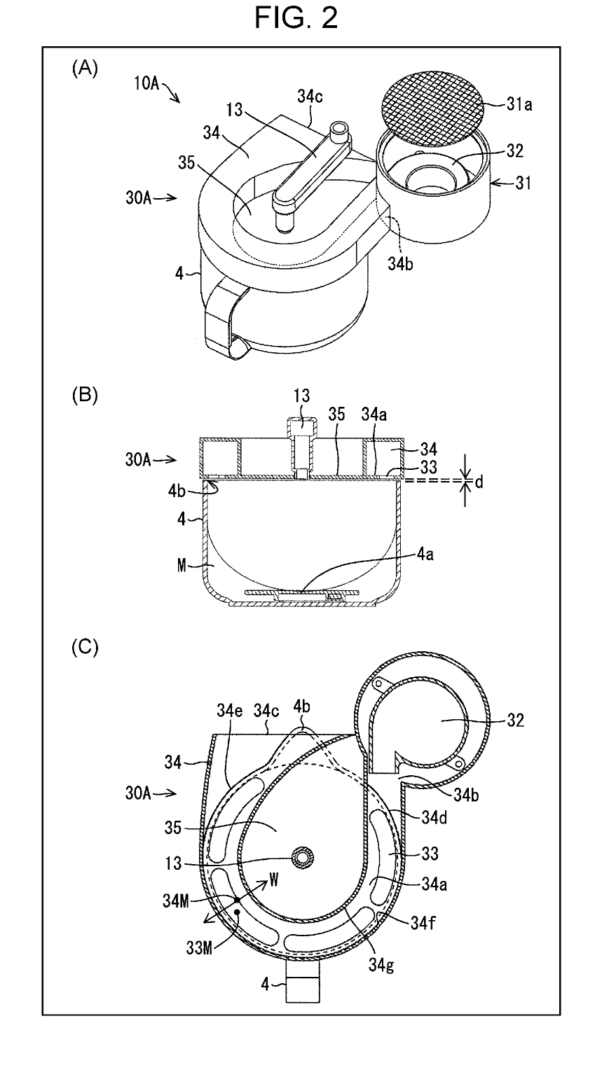

The liquid cooling device 10A according to the embodiment is described on the basis of FIGS. 2(A) to 2(C). For simplifying FIG. 2, the “placement portion 2a” is not shown in FIG. 2.

The liquid cooling device 10A includes the cooling portion 30A, the milk preparing pot 4 (liquid holding container) and the placement portion 2a (not shown) on which the milk preparing pot 4 is placed. The cooling portion 30A includes the air inlet portion 31, the blowing fan 32, and the blowing channel 34 (air passage) having the hole portions 33 at a lower surface, and functions as a temperature adjusting portion that cools the milk M after the mixing. An upstream-side inlet 34b that communicates with the air inlet portion 31 and a downstream-side outlet 34c that communicates with an outside space are provided at the blowing channel 34. The downstream-side outlet 34c is an outlet for discharging air in the inside of the blowing channel 34 to the outside from the device body 2.

The milk preparing pot 4 is a cylindrical container having an open portion 4b at a top portion thereof. The shape of a peripheral edge of the open portion 4b is a circular shape. The shape of the peripheral edge of the open portion 4b is not limited to the circular shape shown in FIGS. 2(A) to 2(C), and may be, for example, an elliptical shape or a polygonal shape.

The fan 32 is accommodated in the inside of the air inlet portion 31. The air inlet portion 31 is formed such that the fan 32 causes outside air to be sucked in and to be blown towards the blowing channel 34. The fan 32 has an air-blowing function for air-cooling the milk M in the inside of the milk preparing pot 4 to a target temperature. As shown in FIG. 2(A), the fan 32 sucks in the outside air via a filter 31a. The fan 32 is connected to the upstream-side inlet 34b of the blowing channel 34. In this way, the liquid cooling device 10A prevents, for example, large dust and foreign substances from moving into the inside of the blowing channel 34.

The blowing channel 34 is disposed directly above the milk preparing pot 4. The diameter of the circular shape of the open portion 4b of the milk preparing pot 4 and the diameter of an outer periphery of the blowing channel 34 are substantially the same. At least a part of the outer periphery of the blowing channel 34 extends along the circular shape of the peripheral edge of the open portion 4b of the milk preparing pot 4. More specifically, in the top view of FIG. 2(C), at least a part of the blowing channel 34 has a ring shape, and is formed by an outer-peripheral inner wall 34f on an outer peripheral side and an inner-peripheral inner wall 34g on an inner peripheral side. The hole portions 33 that communicate with the open portion 4b are provided in an opposing lower surface 34a of the blowing channel 34 that opposes the open portion 4b of the milk preparing pot 4.

Here, as a method of cooling the milk M in the inside of the milk preparing pot 4, a method of directly striking wind sent from the fan 32 against the milk M via the filter 31a may be considered. However, when the wind sent from the fan 32 directly strikes the milk M, finer foreign substances, such as finer dust, which cannot be completely removed by the filter 31a may enter the milk M. When the dust or the like contacts the milk M, surface tension causes the dust or the like to be trapped in and taken in by the milk M. Therefore, the method of directly striking the wind that is sent from the fan 32 against the milk M is an unsuitable method of making drinks to be drunk by a baby.

Even if an airflow from the fan 32 is made to directly strike the milk M, ordinarily, the airflow strongly strikes only a portion of a liquid surface. Therefore, a portion that contributes to cooling the milk M is only a portion where the airflow strikes the milk M. Consequently, it is not possible to efficiently cool the entire liquid surface of the milk M.

Accordingly, in the liquid cooling device 10A of the embodiment, as mentioned above, the blowing channel 34 is positioned directly above the milk preparing pot 4, and at least a part of the outer periphery extends along the circular shape of the peripheral edge of the open portion 4b of the milk preparing pot 4. Further, the hole portions 33 that communicate with the open portion 4b are provided in the opposing lower surface 34a of the blowing channel 34 that opposes the open portion 4b of the milk preparing pot 4. The hole portions 33 are provided from an upstream-side end portion 34d to a downstream-side end portion 34e at the opposing lower surface 34a. The term “opposing lower surface 34a” also refers to an overlapping region where a lower surface of the blowing channel 34 and the open portion 4b of the blowing channel 34 overlap each other in top view as shown in FIG. 2(C).

The term “upstream-side end portion 34d” refers to a portion of an upstream-side-inlet-34b-side end of the opposing lower surface 34a, and the term “downstream-side end portion 34e” refers to a portion of a downstream-side-outlet-34c-side end of the opposing lower surface 34a.

The phrase “the hole portions 33 are provided from an upstream-side end portion 34d to a downstream-side end portion 34e” means that the hole portions 33 do not locally exist at predetermined locations in a region from the upstream-side end portion 34d to the downstream-side end portion 34e at the opposing lower surface 34a. Although, in the structure shown in FIGS. 2(A) to 2(C), a plurality of hole portions 33 are formed, one hole portion 33 may be formed. When one hole portion 33 is formed, the hole portion 33 has the form of an opening portion in which the upstream-side-inlet-34b-side end extends up to the upstream-side end portion 34d, and the downstream-side-outlet-34c-side end extends up to the downstream-side end portion 34e. When a plurality of hole portions 33 are formed, all of the hole portions 33 are formed in the opposing lower surface 34a and are disposed in one row in a direction of extension of the blowing channel 34. Of the plurality of hole portions 33, the hole portion 33 disposed closest to a side of the upstream-side inlet 34b is situated close to the upstream-side end portion 34d, and the hole portion 33 disposed closest to a side of the downstream-side outlet 34c is situated close to the downstream-side end portion 34e.

The blowing channel 34 is provided directly above the milk preparing pot 4 and adjacent to the open portion 4b of the milk preparing pot 4. In order to bring the milk preparing pot 4 close to a sealed state, a gap d between the open portion 4b and the opposing lower surface 34a of the blowing channel 34 is desirably less than or equal to 5 mm, and, more specifically, is more desirably 1 mm. In order to provide the gap d, the milk preparing pot 4 has a structure that allows it to be mounted on the placement portion 2a of the device body 2 only by a sliding operation.

The structure of the milk preparing pot 4 is not limited to one that allows it to be mounted on the placement portion 2a only by a sliding operation. In such a case, the peripheral edge of the open portion 4b and the opposing lower surface 34a of the blowing channel 34 may be in close contact with each other; in other words, the gap d may be 0 mm. A suitable method may be selected to bring the peripheral edge of the open portion 4b and the blowing channel 34 into close contact with each other. For example, a rubber packing or a seal ring may be provided on a peripheral edge portion of the open portion 4b, or the peripheral edge of the open portion 4b may be fixed to the blowing channel 34 with a metal part packing such that the peripheral edge is pushed against the blowing channel 34. However, the method is not limited thereto.

Further, as shown in FIG. 2(C), the blowing channel 34 has a ring shape in top view. A portion directly above the open portion 4b of the milk preparing pot 4 and where the blowing channel 34 does not exist is covered by a cover portion 35. Therefore, the sealability of the inside of the milk preparing pot 4 is further increased; and there is no possibility of foreign substances, such as dust, passing through the portion where the blowing channel 34 does not exist, falling into the milk M from above the milk preparing pot 4, and entering the milk M.

The same cooling performance and the prevention of entry of foreign substances into the milk M can also be achieved by the following structure. That is, the opposing lower surface 34a of the blowing channel 34, where the plurality of hole portions 33 are disposed, and the cover portion 35 are formed so as to be separable from the blowing channel 34, and such that the opposing lower surface 34a and the cover portion 35 are one component. The opposing lower surface 34a and the cover portion 35 that are formed as one component can be mounted on the open portion 4b of the milk preparing pot 4, and serve as a cover of the milk preparing pot 4.

In the case of the above-described structure, a lower portion of the blowing channel 34 is completely open by separating the opposing lower surface 34a. By mounting the milk preparing pot 4 on the placement portion 2a with the cover, in which the opposing lower surface 34a and the cover portion 35 are formed as one component, being mounted on the open portion 4b of the milk preparing pot 4, the lower portion of the blowing channel 34 is covered and an airflow channel is formed. By virtue of such a structure, the lower portion of the blowing channel 34 can be set in an open state, so that the cleanability of the inside of the blowing channel 34 is improved. As a result, it is possible to suppress, for example, bacterial growth in the inside of the blowing channel 34.

The lower surface that is separated from the blowing channel 34 may include at least the blowing channel surface 34a, where the hole portions 33 are formed. For example, the entire lower surface including the opposing lower surface 34a may be formed so as to be separable from the blowing channel 34.

In FIGS. 2(A) to 2(C), at least a part of the blowing channel 34 has a ring shape. However, the blowing channel 34 is not limited to the structures shown in FIGS. 2(A) to 2(C). At least a part of the outer periphery only needs to extend along the peripheral edge of the open portion 4b, so that the structure of the blowing channel 34 depends upon the shape of the peripheral edge of the open portion 4b.

### (Cooling Mechanism of Liquid Cooling Device 10A)

A cooling mechanism of the liquid cooling device 10A is described below on the basis of FIGS. 1 to 4.

When the fan 32 is operating, a main airflow AF1 whose horizontal-direction component in the inside of the blowing channel 34 has a relatively high flow speed is generated. As shown in FIG. 2(C), the main airflow AF1 is a swirling airflow along the outer-peripheral inner wall 34f of the blowing channel 34, and flows in a horizontal direction from the upstream-side inlet 34b towards the downstream-side outlet 34c. In other words, the main airflow AF1 is a swirling flow that flows in a plane that is substantially parallel to the liquid surface of the milk M left standing in the inside of the milk preparing pot 4. Therefore, the main airflow AF1 does not directly strike the milk M in the inside of the milk preparing pot 4.

Here, the hole portions 33 that communicate with the open portion 4b are provided in the opposing lower surface 34a of the blowing channel 34. Therefore, as shown in FIG. 1, air exchange is performed between the air in the inside of the blowing channel 34 and the air in the inside of the milk preparing pot 4 via the hole portions 33. The air exchange causes an auxiliary airflow AF2 branching off from the main airflow AF1 along the outer-peripheral inner wall 34f of the blowing channel 34 and flowing into the milk preparing pot 4 from the hole portions 33 to be generated. The flow speed of a horizontal component of the auxiliary airflow AF2 is maintained relatively high, and, as shown in FIG. 1, is a swirling flow that swirls above the liquid surface of the milk M in the inside of the milk preparing pot 4.

In the inside of the milk preparing pot 4, the milk M is cooled as a result of the auxiliary airflow AF2, which is a swirling flow, striking the liquid surface of the milk M from the horizontal direction. More specifically, the auxiliary airflow AF2, which is a swirling flow branching off into the milk preparing pot 4, strikes the liquid surface of the milk M while swirling along an inside wall of the milk preparing pot 4, and attracts the hot air of the milk M. This takes away the heat from the milk M. The auxiliary airflow AF2 that has taken away the heat from the milk M in this way becomes warm air, and, thus, rises towards the blowing channel 34. Then, by the air exchange with the air in the inside of the blowing channel 34 via the hole portions 33, the auxiliary flow AF2 merges with the main airflow AF1 and is finally discharged to the outside of the device body 2 from the downstream-side outlet 34c.

The auxiliary airflow AF2, which is a swirling flow that is generated in the inside of the milk preparing pot 4, is a flow branched off from the main airflow AF1, which is a swirling flow in the inside of the blowing channel 34. Therefore, similarly to the main airflow AF1, the auxiliary airflow AF2 horizontally strikes the liquid surface of the milk M from the upstream-side end portion 34d towards the downstream-side end portion 34e, that is, from an upstream side towards a downstream side of the main airflow AF1. Consequently, the auxiliary airflow AF2 that has struck the liquid surface of the milk M at the upstream side of the main airflow AF1 takes away the heat from the milk M, becomes warm air, and flows to the downstream side of the main airflow AF1.

Here, the hole portions 33 are provided from the upstream-side end portion to the downstream-side end portion of the blowing channel 34. Therefore, the auxiliary airflow AF2 that has struck the liquid surface of the milk M at the upstream side of the main airflow AF1 takes away the heat from the milk M, and is discharged to the hole portions 33 that exit at the downstream side of the main airflow AF1. That is, an airflow component that, at an upstream side of the blowing channel 34, enters the milk preparing pot 4 from the blowing channel 34 via the hole portions 33 and flows along an upper portion of the milk preparing pot 4, and that, at a downstream side of the blowing channel 34, returns to the blowing channel 34 via the hole portions 33 is formed in the auxiliary airflow AF2. This airflow component allows the hot air of the milk M attracted by the auxiliary airflow AF2 to be discharged smoothly from the hole portions 33 to the blowing channel 34.

In the liquid cooling device 10A according to the embodiment, of the plurality of hole portions 33, at the hole portions 33 disposed on the upstream side of the main airflow AF1, the amount of air that enters the milk preparing pot 4 and becomes the auxiliary airflow AF2 is larger than the amount of auxiliary airflow AF2 that takes away the heat from the milk M and is discharged to the blowing channel 34 from the milk preparing pot 4. In contrast, of the plurality of hole portions 33, at the hole portions 33 disposed on the downstream side of the main airflow AF1, the amount of auxiliary airflow AF2 that takes away the heat from the milk M and is discharged to the blowing channel 34 from the milk preparing pot 4 is larger than the amount of air that enters the milk preparing pot 4 and becomes the auxiliary airflow AF2.

Accordingly, the liquid cooling device 10A has a structure in which, instead of causing the airflow generated by the fan 32 to directly strike the liquid surface of the milk M from a perpendicular direction, the main airflow AF1, which is a horizontal-direction airflow generated by the fan 32, is indirectly branched to generate the auxiliary airflow AF2 in the inside of the milk preparing pot 4. In addition, in the liquid cooling device 10A, the indirectly branched off auxiliary airflow AF2 strikes the liquid surface of the milk M to cool the milk M. The auxiliary airflow AF2 in the inside of the milk preparing pot 4 is such that the flow speed of the horizontal-direction airflow component that flows along the liquid surface of the milk M is relatively high. Therefore, the auxiliary airflow AF2 strikes the entire liquid surface, instead of a part of the liquid surface. As a result, according to the liquid cooling device 10A, it is possible to efficiently take away the heat from the entire liquid surface of the milk M and to efficiently cool the milk M.

Since the flow speed of the horizontal-direction airflow component of the auxiliary airflow AF2 is relatively high, the liquid cooling device 10A can reduce the amount of foreign substances, such as dust, that are trapped in the milk M than the structure in which the airflow perpendicularly strikes the liquid surface of the milk M.

It is desirable that the shape of the peripheral edge of the open portion 4b of the milk preparing pot 4 be a circular shape. In this case, as shown in FIG. 2(C), the blowing channel 34 extends along an arc shape of the peripheral edge of the open portion 4b with the center of the open portion 4b as a center. Therefore, a part of the shape of the blowing channel 34 is a ring shape. Consequently, the main airflow AF1 that flows in the blowing channel 34 becomes a swirling flow, and centrifugal force is produced in the main airflow AF1.

Thus, even if foreign substances, such as dust, are contained in the main airflow AF1, the foreign substances flow along the outer-peripheral inner wall 34f on the outer peripheral side of the blowing channel 34 due to the centrifugal force, and the entry of foreign substances into the milk preparing pot 4 from the hole portions 33 is suppressed.

In the cooling device 10A according to the embodiment, it is desirable that the upstream-side inlet 34b of the blowing channel 34 be open in a tangential direction of the ring shape of the blowing channel 34. This makes it possible to efficiently generate the main airflow AF1, which is a swirling flow, in the inside of the blowing channel 34.

When a part of the shape of the blowing channel 34 is a ring shape, in order to form the aforementioned auxiliary airflow AF2, which is a swirling flow, it is desirable that, of the peripheral edge of the open portion 4b, the blowing channel 34 extend along a region of the peripheral edge extending 180 degrees or more with the center of the open portion 4b as a center. In this case, the hole portions 33 are also similarly disposed 180 degrees or more with the center of the open portion 4b as a center from the upstream-side end portion 34d of the blowing channel 34 to the downstream-side end portion 34e thereof.

As shown in FIG. 2(C), an outer-peripheral-side peripheral edge of each hole portion 33 that is formed in the opposing lower surface 34a of the blowing channel 34 is disposed along the outer-peripheral inner wall 34f of the blowing channel 34 and along an inner periphery of the milk preparing pot 4 in top view. If the hole portions 33 are disposed as described above, when the main airflow AF1 in the inside of the blowing channel 34 is branched and the branched-off airflow flows into the milk preparing pot 4 via the hole portions 33, and when the auxiliary airflow AF2 in the inside of the milk preparing pot 4 merges with the main airflow AF1 in the inside of the blowing channel 34 via the hole portions 33, a member that disturbs the airflows does not exist. Therefore, the main airflow AF1 in the blowing channel 34 enters the milk preparing pot 4 as a swirling flow via the hole portions 33 with the directivity of the flow being maintained without the flow being disturbed. The auxiliary airflow AF2 in the inside of the milk preparing pot 4 is discharged from the milk preparing pot 4 as a swirling flow via the hole portions 33 and merges with the main airflow AF1 with the directivity of the flow being maintained without the flow being disturbed. Therefore, the milk M can be cooled very efficiently with air in addition to the amount of foreign substances, such as dust, that enter the milk M being small.

The peripheral edge on an inner peripheral side of each hole portion 33 that is formed in the opposing lower surface 34a of the blowing channel 34 is disposed apart from the inner-peripheral inner wall 34g of the blowing channel 34. As shown in FIG. 2(C), a center position 33M of a hole portion 33 is disposed outwardly of a center position 34M of the blowing channel 34 in a width direction W. Here, the term “width direction W” may also refer to a direction perpendicular to a direction of the main airflow AF1 or a radial direction of the ring that defines the blowing channel 34.

Foreign substances, such as dust, contained in the main airflow AF1 flow along the outer-peripheral inner wall 34f due to centrifugal force. Therefore, since the peripheral edge of each hole portion 33 is disposed apart from the outer-peripheral inner wall 34f, the foreign substances, such as dust, do not easily enter the milk preparing pot 4 from the hole portions 33. This suppresses the entry of foreign substances, such as dust, into the milk M. Here, a plurality of hole portions 33 may be provided, and outer peripheral edges of all of the hole portions 33 may be provided apart from the outer-peripheral inner wall 34f. This causes the main airflow AF1 that flows in the blowing channel 34 and that contains foreign substances, such as dust, and the auxiliary airflow AF2 that enters the milk preparing pot 4 to be separately formed. As a result, it is possible to suppress the entry of foreign substances, such as dust, into the milk M while efficiently cooling the milk M by the auxiliary airflow AF2.

The shape of the peripheral edge of each hole portion 33 is long in the direction of extension of the blowing channel 34. Therefore, airflow exchange between the main airflow AF1 and the auxiliary airflow AF2 occurs easily, so that the milk M can be efficiently cooled.

The gap d between the open portion 4b and the opposing lower surface 34a of the blowing channel 34 is less than or equal to 5 mm, and is very small. Therefore, the possibility of foreign substances, such as dust, entering the inside of the milk preparing pot 4 from the gap d along with outside air is reduced. When the gap d between the open portion 4b and the opposing lower surface 34a of the blowing channel 34 is greater than or equal to 5 mm, the airflow leaks from the gap d, and the auxiliary airflow AF2, which is a swirling flow along the liquid surface of the milk M, is not easily generated in the inside of the milk preparing pot 4.

The liquid cooling device 10A of the embodiment has a structure in which the blowing fan 32 is connected as an airflow generating unit to the upstream-side inlet 34b of the blowing channel 34. However, the airflow generating unit of the liquid cooling device 10A according to the embodiment is not limited to the fan 32, and is not particularly limited as along as the main airflow AF1 can be generated in the inside of the blowing channel 34. For example, the airflow generating unit may be a suction pump connected to the downstream-side outlet 34c of the blowing channel 34.

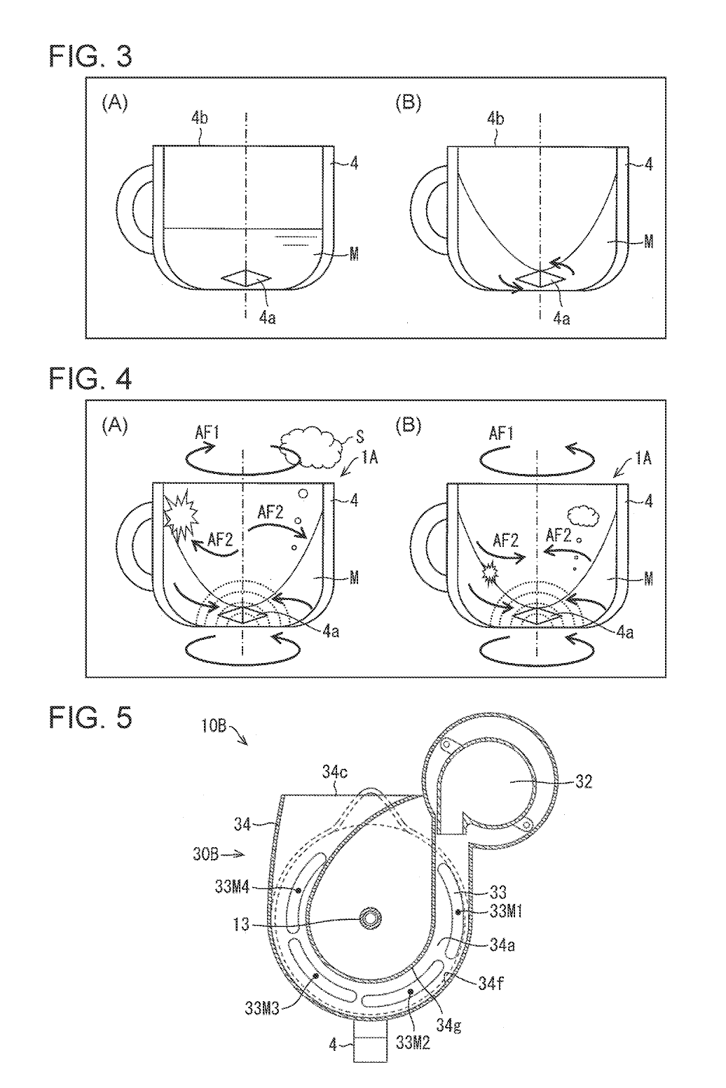

Further, since the cooling process performed by the fan 32 is performed at the same time as the stirring step performed by the stirrer 4a, the milk M is more easily cooled. This principle is described on the basis of FIGS. 3(A) and 3(B).

As shown in FIG. 3(A), the state of the liquid surface of the milk M in the inside of the milk preparing pot 4 with the stirrer 4a in a stopped state is a horizontal state. In contrast, as shown in FIG. 3(B), when the stirrer 4a is rotating, an outer side of the liquid surface rises and the central portion thereof moves downward due to centrifugal force. In such a state, the contact area between the milk M and the inner surface of the milk preparing pot 4 and the surface area of the milk M are both increased. Therefore, the heat-dissipation area of the milk M is increased, and the milk M is easily cooled. Since the liquid surface changes in such a way, the size of the milk preparing pot 4 needs to sufficiently larger than the preparation amount of the milk M.

Here, by making the rotation speed of the stirrer 4a as high as possible, and making the contact area between the milk M and the inner surface of the milk preparing pot 4 and the surface area of the milk M as large as possible, it is possible to cool the milk M more quickly. However, when the rotation speed is high, the milk M tends to, for example, splash or swell, as a result of which the milk M takes in a large amount of air bubbles. The milk M that contains the air bubbles increases the amount of air that enters the stomach of a baby during feeding. As a result, the baby tends to let out a loud belch, and a baby that is still not able to belch properly tends to regurgitate the milk when the baby belches. Such regurgitation of the milk M requires the mother or other persons to feed the baby again or the mother or other persons to feed the baby frequently, as a result of which the burden on the person who feeds the baby, such as the mother, is considerably increased. Therefore, a method of making the milk M containing a large amount of air bubbles is a very unsuitable method as a method of making the milk M that is given to a baby. Accordingly, a liquid cooling method that can reduce the amount of air bubbles contained in the milk M is desired.

More specifically, as a method of reducing the amount of air bubbles contained in the milk M, in the embodiment, the cooling process that is performed by the cooling portion 30A is performed at the same time as the stirring process performed by the stirrer 4a, and a rotation direction of the stirrer 4a and a direction of the auxiliary airflow AF2 are made to oppose each other. This allows the milk M to be more easily cooled, and the amount of air bubbles contained to be reduced.

This principle is described on the basis of FIGS. 4(A) and 4(B). FIG. 4(A) is a sectional view of a state of heat dissipation and defoaming in the inside of the milk preparing pot 4 with the stirrer 4a of the milk preparing pot 4 in the powdered formula preparing device 1A in a rotating state, and of a mixed state with the rotation direction of the stirrer 4a and the direction of the auxiliary airflow AF that is generated in the inside of the milk preparing pot 4 opposing each other (hereunder referred to as “counterflow mixed state”). FIG. 4(B) is a sectional view of a state in which the rotation direction of the stirrer 4a and the direction of the auxiliary airflow AF2 that is generated in the inside of the milk preparing pot 4 are the same (hereunder referred to as “parallel-flow mixed state”).

As shown in FIG. 4(A), in the counterflow mixed state in the embodiment, the rotation direction of the stirrer 4a and the direction of the auxiliary airflow AF2 that is indirectly generated in the inside of the milk preparing pot 4 by the main airflow AF1 in the inside of the blowing channel 34 oppose each other. Therefore, the wind speed at which the airflow strikes the liquid surface of the milk M that is being stirred increases to a wind speed equal to the wind speed of the auxiliary airflow AF2 added to the rotation speed of the stirrer 4a. As a result, heat exchange between the liquid surface of the milk M and the air near the liquid surface is accelerated, and hot air S is discharged along with the auxiliary airflow AF2 to the blowing channel 34 from the hole portions 33. A slight airflow that is generated in the inside of the milk preparing pot 4 by stirring the milk M is absorbed by the auxiliary airflow AF2, so that the hot air S in the inside of the milk preparing pot 4 is attracted and sent above the milk preparing pot 4. The hot air that has been sent above the milk preparing pot 4 merges with the main airflow that flows at a higher flow speed in the inside of the blowing channel 34, and is successively sent to the downstream-side outlet 34c. As a result, the removal of hot air and stream generated in the mixture is accelerated. Therefore, heat exchange between the milk M and air is accelerated, and the milk M can be cooled more quickly.

In the counterflow mixed state in the embodiment, by causing the rotation direction of the stirrer 4a and the direction of the auxiliary airflow AF2 to oppose each other, defoaming of air bubbles produced in the mixture is accelerated compared to the parallel-flow mixed state shown in FIG. 4(B). This is because an airflow that is generated in the inside of the milk preparing pot 4 by the auxiliary airflow AF2 collides with the air bubbles at the liquid surface of the milk M and exerts pressure on the air bubbles, and moves the air bubbles, so that friction or the like is produced between the air bubbles, and the air bubbles tend to burst. Therefore, in the embodiment, the milk M containing a small amount of air bubbles can be produced. At this time, it is steam discharged from the milk M and existing near the liquid surface of the milk M that collides with the liquid surface of the milk M, and the frequency with which the auxiliary airflow AF2, itself, collides with the liquid surface of the milk M is small. Therefore, the entry of foreign substances, such as dust, into the milk M is suppressed.

Referring to FIGS. 1 to 4(A) and 4(B) again, the powdered formula preparing device 1A of the embodiment includes the heater 12, which serves as a liquid heating portion that heats the liquid L that is supplied; the milk preparing pot 4, which serves as a mixture preparing portion that prepares the milk M, serving as a mixture, as a result of adding the liquid L that has been heated by the heater 12 to the powdered milk PM, serving as a mixture raw material; and the cooling portion 30A for cooling the milk M prepared by the milk preparing pot 4 to a suitable temperature.

The milk preparing pot 4 includes the stirrer 4a, which serves as a rotating mechanism that rotates and mixes the powdered milk PM and the liquid L. The thermistor TM, which serves as a temperature measuring unit that detects the temperature of the milk M, contacts the outer wall of the milk preparing pot 4. Further, the controller 7 that changes the rotation of the stirrer 4a on the basis of the temperature value of the thermistor TM is provided.

The liquid cooling device 10A according to the embodiment includes the milk preparing pot 4 having the open portion 4b, the placement portion 2a on which the milk preparing pot 4 is mounted, the blowing channel 34, and the fan 32 that generates the main airflow AF1 along the blowing channel 34 in the inside of the blowing channel 34. The blowing channel 34 is positioned directly above the open portion 4b, and at least a part of its outer periphery extends along the peripheral edge of the open portion 4b. The hole portions 33 that communicate with the open portion 4b are provided in the lower surface of the blowing channel 34 from the upstream-side end portion 34d of the blowing channel 34 to the downstream-side end portion 34e thereof. The cooling portion 30A of the powdered formula preparing device 1A includes the fan 32 and the blowing channel 34.

In the powdered formula preparing device 1A of this type, since the milk M prepared by the milk preparing pot 4 is hot, the milk M needs to be cooled to a suitable temperature. Hitherto, a technology in which hot air of the milk M is attracted and discharged by direct air-blowing on the outer wall of the milk preparing pot 4 or air-blowing towards a space above the milk preparing pot 4 has been proposed. However, in such an existing technology, the milk M in the milk preparing pot 4 cannot be efficiently cooled.

Therefore, in the embodiment, the blowing channel 34 is positioned directly above the open portion 4b, and at least a part of its outer periphery extends along the peripheral edge of the open portion 4b. The hole portions 33 that communicate with the open portion 4b are provided in the lower surface of the blowing channel 34 from the upstream-side end portion 34d of the blowing channel 34 to the downstream-side end portion 34e thereof.

According to the above-described structure, when an airflow that is sent from the fan 32 enters the blowing channel 34, the main airflow AF1 that flows horizontally in the blowing channel 34 and the auxiliary airflow AF2 that enters the milk preparing pot 4 while swirling along an inner wall of the milk preparing pot 4 from the hole portions 33 in the lower surface of the blowing channel 34 are generated. The auxiliary airflow AF2 that has entered the milk preparing pot 4 while swirling along the inner wall of the milk preparing pot 4 generates a swirling flow whose horizontal-direction component has a high flow speed, and rises while attracting the hot air of the milk M. The auxiliary airflow AF2 flows again through the hole portions 33 in the lower surface of the blowing channel 34 and merges with the main airflow AF1 in the blowing channel 34. Since the hole portions 33 in a bottom surface of the blowing channel 34 are disposed along the inner periphery of the cylindrical container of the milk preparing pot 4, when the auxiliary airflow AF2 in the inside of the milk preparing pot 4 branches off from the main airflow AF1 in the inside of the blowing channel 34, and when the auxiliary airflow AF2 in the milk preparing pot 4 merges with the main airflow AF1 in the blowing channel 34, the airflows flow in and out with the directivities of the swirling flows being maintained without the swirling flows being disturbed. Therefore, in addition to the amount of foreign substances, such as dust, that enter the milk M being small, the milk M can be cooled very efficiently with air.

Further, in the embodiment, since the stirrer 4a that rotates and mixes the powdered milk PM and the liquid L in the inside of the milk preparing pot 4 is provided, the powdered milk PM and the liquid L in the inside of the milk preparing pot 4 are stirred and mixed in addition to being air-blown by using the fan 32. Therefore, it is possible to more efficiently cool the milk M than when the milk M is cooled only by air-blowing.

Therefore, on the basis of the above, the embodiment makes it possible to provide the liquid cooling device 10A whose cooling efficiency is improved and the powdered formula preparing device 1A including the liquid cooling device 10A.

In the liquid cooling device 10A shown in FIGS. 2(A) to 2(C), the center position 33M of the hole portion 33 is disposed outwardly of the center position 34M of the blowing channel 34 in the width direction W. However, the hole portions 33 of the liquid cooling device 10A according to the embodiment are not limited in structure to those shown in FIGS. 2(A) to 2(C).

The center position 33M of each hole portion 33 may be positioned inwardly of the center position 34M of the blowing channel 34 in the width direction W. In this case, it is possible to further suppress the entry of foreign substances, such as dust, that flow along the outer-peripheral inner wall 34f into the milk M in the milk preparing pot 4 from the hole portions 33. At this time, a plurality of hole portions 33 may be provided, and the center positions of all of the hole portions 33 may be positioned inwardly of the center position of the blowing channel 34 in the width direction.

### Second Embodiment

A second embodiment of the present invention is described. Structures that are the same as those of the first embodiment are not described.

As shown in FIG. 5, the liquid cooling device 10B of the embodiment includes a cooling portion 30B that differs from the cooling portions 30A to 30D described in the first embodiment. More specifically, a blowing channel 34B of the cooling portion 30B includes a plurality of hole portions 33 in an opposing lower surface 34a. The liquid cooling device 10B of the embodiment differs from the cooling portion 30A of the first embodiment in that, from an upstream side of a main airflow AF1 that flows in the blowing channel 34 to a downstream side thereof, the plurality of hole portions 33 are provided such that center positions 33M1 to 33M4 of the corresponding hole portions 33 are gradually shifted towards an inner-peripheral inner wall 34g of the blowing channel 34.

According to this structure, even if foreign substances, such as dust, that are finer than the mesh of a filter mounted on an air inlet portion 31 enter the blowing channel 34 due to air-blowing by a fan 32, the foreign substances, such as dust, can be discharged from a downstream-side outlet 34c without entering the milk preparing pot 4 via the hole portions 33.

That is, fine foreign substances, such as fine dust, contained in the main airflow AF1 in the blowing channel 34, is subjected to centrifugal force due to the main airflow AF1, which is a swirling flow in the inside of the blowing channel 34; and flow along an outer-peripheral inner wall 34f of the blowing channel 34. Here, since the hole portions 33 are disposed such that the closer the hole portions 33 are to a downstream side, the further away the hole portions 33 are from the outer-peripheral inner wall 34f of the blowing channel 34, the probability of the foreign substances, such as dust, entering the milk preparing pot 4 via the hole portions 33 is considerably reduced. Therefore, it is possible to cool the milk M where the entry of the foreign substances, such as dust, has been further suppressed.

Further, in order to prevent the entry of foreign substances, such as dust, into the milk M, the mesh of the filter no longer needs to be made finer than is necessary, so that not only is it possible to reduce the size of the fan 32, but also a sufficient air-blowing amount of the fan 32 can be provided, and efficient air-cooling can be realized.

However, FIG. 3 based on the embodiment shows a disposition of the hole portions 33 when the outside diameter of the milk preparing pot 4 and the outside diameter of the blowing channel 34 are about the same. Therefore, FIG. 3 shows that, as the hole portions 33 are shifted towards the inner-peripheral inner wall 34g with decreasing distance from the downstream side of the blowing channel 34, the hole portions 33 are disposed further away from a peripheral edge of an open portion 4b of the milk preparing pot 4.

Therefore, when the outside diameter of the blowing channel 34 is allowed to be greater than the outside diameter of the milk preparing pot 4, it is desirable that the hole portions 33 that are formed in a lower surface of the blowing channel 34 be disposed such that an outer peripheral side of a peripheral edge of each hole portion 33 be situated along the peripheral edge of the open portion 4b of the milk preparing pot 4, in addition to the hole portions 33 being gradually shifted towards an inner side from an upstream side of the blowing channel 34 to the downstream side thereof.

Accordingly, when an auxiliary airflow AF2 becomes a swirling flow and merges with the main airflow AF1 in the inside of the blowing channel 34 via the hole portions 33, the auxiliary airflow AF2 passes through the hole portions 33 along an inner periphery of the milk preparing pot 4, and can smoothly merge with the main airflow in the blowing channel 34. Therefore, very efficient air-cooling can be realized, in addition to the amount of foreign substances, such as dust, that enter the milk M being small.

### Third Embodiment

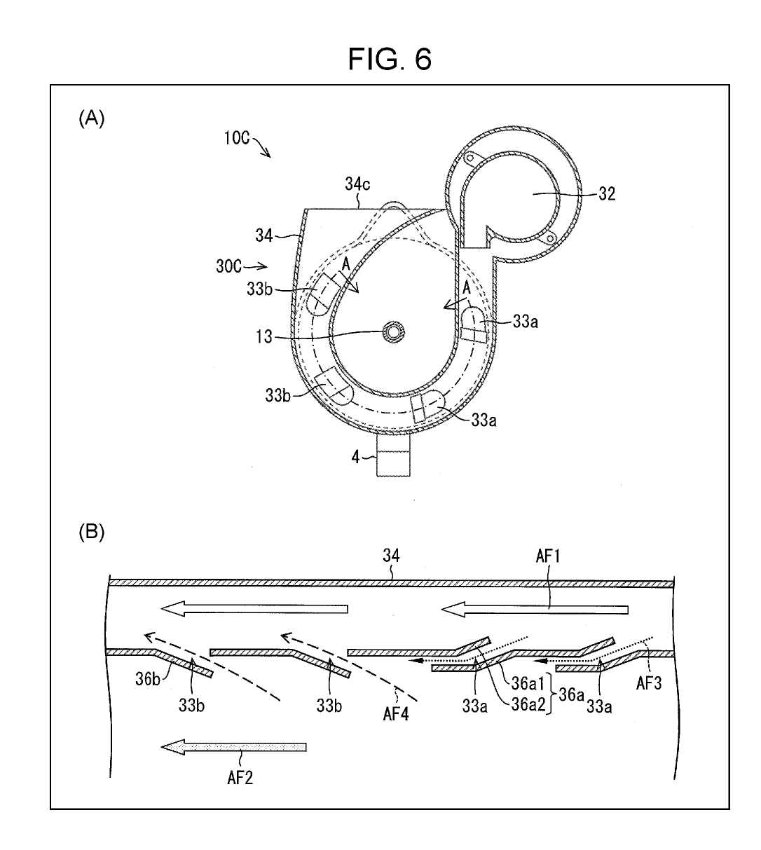

Another embodiment of the present invention is described on the basis of FIGS. 6(A) and 6(B), and the description is as follows. Structures other than those described in the embodiment are the same as those of the first and second embodiments. For the purpose of illustration, members having the same functions as those of the members described in the first and second embodiments are given the same reference numerals, and are not described below.

FIG. 6(A) is a top view of a liquid cooling device 10C according to the embodiment, and FIG. 6(B) is a sectional view along arrow A-A in FIG. 6(A).

The liquid cooling device 10C includes a cooling portion 30C, a milk preparing pot 4, and a placement portion 2a. In the cooling portion 30A of the liquid cooling device 10A of the first embodiment and the cooling portion 30B of the liquid cooling device 10B of the second embodiment, the hole portions 33 of the blowing channel 34 are such that only through holes are formed in the opposing lower surface 34a of the blowing channel 34. In contrast, in the cooling portion 30C of the embodiment, hole portions 33 of the blowing channel 34 are of two types, hole portions 33a and hole portions 33b. The hole portions 33a are provided with send-out straightening plates 36a that form a flow from the blowing channel 34 towards the milk preparing pot 4. The hole portions 33b are provided with take-in straightening plates 36b that form a flow from the milk preparing pot 4 towards the blowing channel 34.

Hereunder, an airflow that branches off from a main airflow AF1 and flows into the milk preparing pot 4 is called a branch airflow AF3, and an airflow that is discharged from the milk preparing pot 4 and that merges with the main airflow AF1 is called a merging airflow AF4. As shown in FIG. 6(B), the branch airflow AF3 and the merging airflow AF4 are generated at the hole portions 33 corresponding thereto.

The proportion between the branch airflow AF3 and the merging airflow AF4 at the hole portions 33 is as follows. That is, the closer the hole portions 33 are to an upstream side of the blowing channel 34, the larger the amount of branch airflow AF3 and the smaller the amount of merging airflow AF4. In contrast, the closer the hole portions 33 are to a downstream side of the blowing channel 34, the smaller the amount of branch airflow AF3 and the larger the amount of merging airflow AF4. Therefore, as a whole, an airflow that has been sent into the milk preparing pot 4 from the main airflow AF1 via the hole portions 33 forms the auxiliary airflow AF2.

Here, in the embodiment, the send-out straightening plates 36a that form a flow from the blowing channel 34 towards the milk preparing pot 4 are provided at the hole portions 33a that are positioned on the upstream side of the blowing channel 34. Therefore, only the branch airflow AF3 is generated at the hole portions 33a. The take-in straightening plates 36b that form a flow that form a flow from the milk preparing pot 4 towards the blowing channel 34 are provided at the hole portions 33b that are positioned on the downstream side of the blowing channel 34. Therefore, only the merging airflow AF4 is generated at the hole portions 33b.

Exemplary structures of such send-out straightening plates 36a and take-in straightening plates 36b are described below on the basis of FIG. 6(B). The structures thereof are not limited to those described below as long as the send-out straightening plates 36a and take-in straightening plates 36b have the functions described above.

As shown in FIG. 6(B), each send-out straightening plate 36a includes a first send-out straightening plate 36a1 that is situated at a lower surface of the blowing channel 34 and that is bent towards a side of the milk preparing pot 4 from the upstream side towards the downstream side. Each send-out straightening plate 36a also includes a second send-out straightening plate 36a2 that is bent towards the inside of the blowing channel 34 from the downstream side towards the upstream side. Each first send-out straightening plate 36a1 and its corresponding second send-out straightening plate 36a2 have adjacent portions where their bent portions are adjacent to each other. Spaces between the corresponding adjacent portions form the corresponding hole portions 33a, which are paths for guiding the main airflow AF1 to the milk preparing pot 4.

Here, the auxiliary airflow AF2 in the inside of the milk preparing pot 4 is a swirling flow that flows in the same direction as the main airflow AF1. Therefore, even if the auxiliary airflow AF2 is about to enter the blowing channel 34 via the hole portions 33a, its course is completely blocked by the first send-out straightening plates 36a1. Therefore, the auxiliary airflow AF2 in the inside of the milk preparing pot 4 cannot enter the blowing channel 34 via the hole portions 33a.

Each take-in straightening plate 36b is situated at the lower surface of the blowing channel 34 and is bent towards the side of the milk preparing pot 4 from the downstream side towards the upstream side. Spaces between the bent take-in straightening plates 36b and the lower surface of the blowing channel 34 form the corresponding hole portions 33b, which are paths for guiding air in the inside of the milk preparing pot 4 towards the blowing channel 34.

Here, the direction of the main airflow AF1 and the direction of the merging airflow AF4 that passes through the hole portions 33b and merges with the main airflow AF1 are substantially the same. Even if the main airflow AF1 is about to enter the milk preparing pot 4 from the hole portions 33b, the merging airflow AF4 flows continuously from the hole portions 33b and the take-in straightening plates 36b block its course towards the milk preparing pot 4. Therefore, the main airflow AF1 cannot flow into the milk preparing pot 4 via the holes portions 33b.

Therefore, the hole portions 33a and the hole portions 33b cause the air in the inside of the blowing channel 34 and the air in the inside of the milk preparing pot 4 to be smoothly and efficiently exchanged. This causes the flow of the main airflow AF1 and the flow of the auxiliary airflow AF2 to have excellent directivities, so that very efficient air-cooling can be realized.

Further, by causing the angle of the first send-out straightening plate 36a1 of each send-out straightening plate 36a at a portion where an airflow is sent out towards the milk preparing pot 4 to approach a horizontal angle, the auxiliary airflow AF2 that is formed by the branch airflow AF3 is less likely to strike the liquid surface of the milk M, so that the entry of foreign substances, such as dust, into the milk M can be suppressed.

### Fourth Embodiment

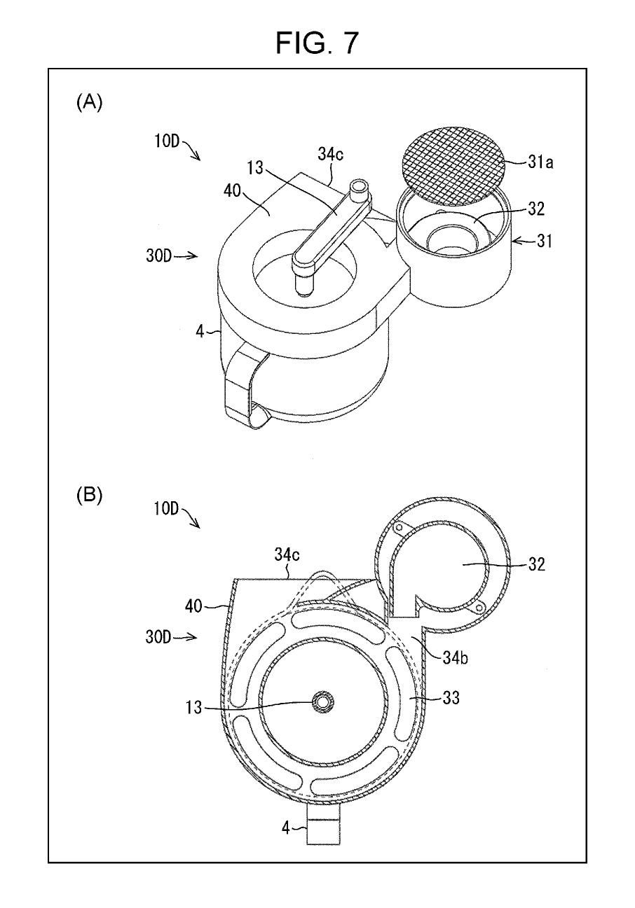

Another embodiment of the present invention is described on the basis of FIGS. 7(A) and 7(B), and the description is as follows. Structures other than those described in the embodiment are the same as those of the first to third embodiments. For the purpose of illustration, members having the same functions as those of the members described in the first to third embodiments are given the same reference numerals, and are not described below.

FIG. 7(A) is a perspective view of a liquid cooling device 10D according to the embodiment, and FIG. 7(B) is a top view.

The liquid cooling device 10D includes a cooling portion 30D, a milk preparing pot 4, and a placement portion 2a. The cooling portion 30D of the embodiment differs from the cooling portions 30A to 30C of the first to third embodiments in that a blowing channel 34 is a circulation path 40 extending along the entire peripheral edge of an open portion 4b, and in that a part of the circulation path 40 has a downstream-side outlet 34c that discharges a part of air to the outside.

That is, whereas the blowing channels 34 of the cooling portions 30A to 30C of the first to third embodiments are each a unidirectional channel in which air that is sucked in from the air inlet portion 31 by the fan 32 is sent towards the downstream-side outlet 34c, the circulation path 40, which serves as a blowing channel of the embodiment, forms a channel that not only allows air sucked in from the air inlet portion 31 to be sent to the downstream-side outlet 34c, but also allows a part of the air to return again to the vicinity of an upstream-side inlet 34b.

Therefore, hole portions 33 of the circulation path 40 can be disposed 360° along an inner periphery of a milk preparing pot 4. Therefore, the total opening area of the hole portions 33 is increased, and a strong swirling flow in a horizontal direction is generated in both the inside of the circulation path 40 and the inside of the milk preparing pot 4, so that heat exchange with milk M can be efficiently performed.

Foreign substances, such as dust, that may be contained in a main airflow AF1 moves along an outer-peripheral inner wall 34f due to centrifugal force that is generated in the main airflow AF1, which is a swirling flow. Here, in the circulation path 40, when the main airflow AF1 moves along the outer-peripheral inner wall 34f, the main airflow AF1 is guided from the upstream-side inlet 34b towards the downstream-side outlet 34c. Therefore, the foreign substances, such as dust, that have moved along the outer-peripheral inner wall 34f are discharged to the outside of a device body 2 from the downstream-side outlet 34c without circulating in the circulation path 40.

Consequently, it is possible to suppress the entry of foreign substances, such as dust, into the milk M by causing the foreign substances, such as dust, to move along the outer-peripheral inner wall 34f while efficiently cooling the milk M by the strong swirling flow in the horizontal direction.

### Fifth Embodiment

A fifth embodiment of the present invention is described. Structures that are the same as those of the first to fourth embodiments are not described.

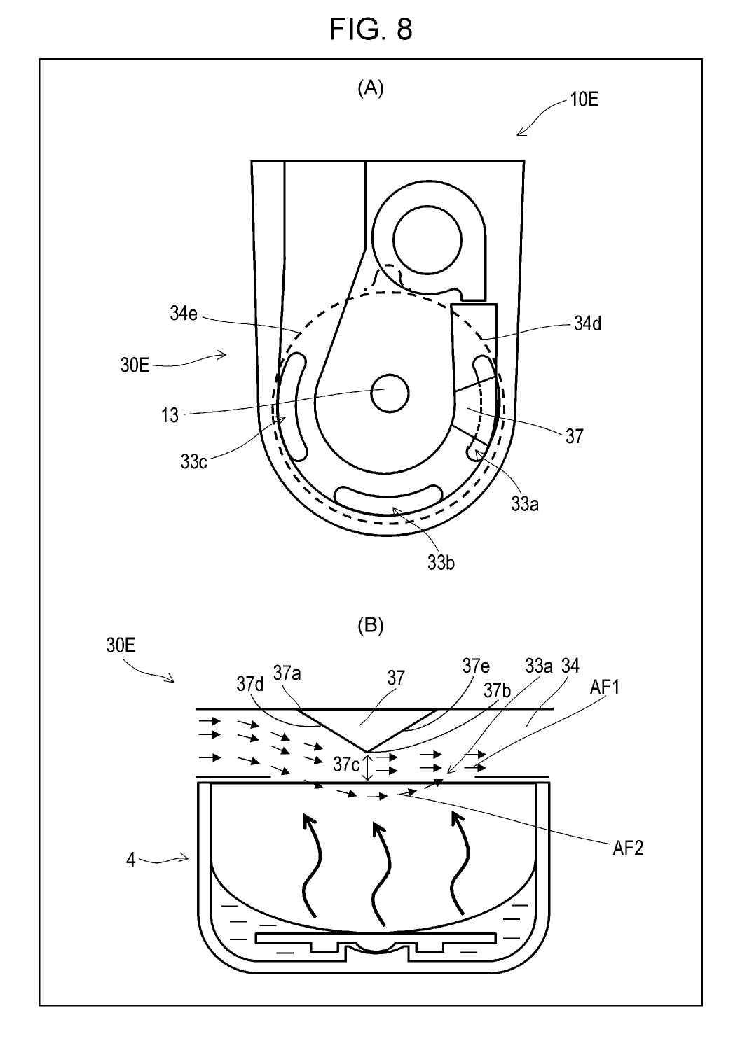

As shown in FIGS. 8(A) and 8(B), a liquid cooling device 10E of the embodiment includes a cooling portion 30E that differs from the cooling portions 30A to 30D described in the first to fourth embodiments. More specifically, the cooling portion 30E includes a guide portion 37 in a blowing channel 34.

Here, a disposition of hole portions 33 of the embodiment is described. The hole portions 33 of the embodiment are provided in an opposing lower surface 34a from an upstream-side end portion 34d to a downstream-side end portion 34e. Although, in the first to fourth embodiments, an example in which four hole portions 33 are formed is described, in the embodiment, another example in which three hole portions 33 are formed is described.

As shown in FIG. 8(A), in the embodiment, in the opposing lower surface 34a, a hole portion 33a is disposed on a side of the upstream-side end portion 34d, and a hole portion 33c is disposed on a side of the downstream-side end portion 34e. In the embodiment, a hole portion 33b extends from a rear side towards a front side of the liquid cooling device 10E, curves at the front side of the liquid cooling device 10E and extends towards the rear side, and is disposed at a location on the front side of the liquid cooling device 10E in the blowing channel 34.

Similarly to the hole portions 33 according to the first embodiment, an outer-peripheral-side peripheral edge of each of the hole portions 33a to 33c of the embodiment is disposed along an outer-peripheral inner wall 34f of the blowing channel 34 and along an inner periphery of a milk preparing pot 4 in top view. An inner-peripheral-side peripheral edge of each of the hole portions 33a to 33c of the embodiment is disposed apart from the outer-peripheral inner wall 34f of the blowing channel 34. Similarly to the hole portions 33 according to the first to fourth embodiments, the shape of the peripheral edge of each of the hole portions 33a to 33c is long in a direction of extension of the blowing channel 34.

As shown in FIG. 8(A), the guide portion 37 is disposed in a region above the hole portion 33a that is disposed closest to a side of the upstream-side end portion 34d. The guide portion 37 is disposed in correspondence with a central portion of the region above the hole portion 33a.

As shown in FIG. 8(B), the guide portion 37 is provided in a state in which its upper end portion 37a contacts an upper surface of the blowing channel 34 and protrudes from the upper surface to a lower surface (including the opposing lower surface 34a) of the blowing channel 34. A protruding end 37b (lower end in FIG. 8(B)) of the guide portion 37 does not contact the lower surface of the blowing channel 34. A gap 37c for allowing a main airflow AF1 to pass therethrough is formed between the protruding end 37b and the lower surface of the blowing channel 34.

More specifically, the guide portion 37 includes a first inclined surface 37d that is formed on an upstream side of the blowing channel 34 such that the distance between it and the lower surface of the blowing channel 34 gradually becomes smaller from the upstream side towards a downstream side. The guide portion 37 also includes a second inclined surface 37e that is formed on a downstream side thereof such that the distance between it and the lower surface of the blowing channel 34 gradually becomes larger from the upstream side towards the downstream side. That is, the vertical sectional shape of the guide portion 37 along the blowing channel 34 is an inverted triangular shape.

The guide portion 37 is capable of changing the direction of flow of the main airflow AF1 that is going to flow in a horizontal direction in the blowing channel 34. More specifically, when the main airflow AF1 flows along the first inclined surface 37d, the direction of flow of the main airflow AF1 changes to an obliquely downstream direction (towards a side of the milk preparing pot 4). Therefore, a part of the main airflow AF1 becomes an auxiliary airflow AF2, is guided into the milk preparing pot 4 from the hole portion 33, and enters the milk preparing pot 4. Then, the auxiliary airflow AF2 becomes a swirling flow in the milk preparing pot 4, mixes air in the milk preparing pot 4, rises while attracting hot air of the milk M, and merges again with the main airflow AF1 in the blowing channel 34 from the hole portion 33. In this way, when the guide portion 37 is provided at the blowing channel 34, the auxiliary airflow AF2 that has branched off from the main airflow AF1 can be positively guided into the milk preparing pot 4. Therefore, the milk M in the inside of the milk preparing pot 4 is efficiently cooled.

Of the main airflow AF1, an airflow component that did not become the auxiliary airflow AF2 passes through the gap 37c, moves beyond the guide portion 37, and is guided to the upper surface of the blowing channel 34 along the second inclined surface 37e. At this time, with the flow speed maintained to a certain extent, the airflow component merges again with the auxiliary airflow AF2 that has attracted the hot air of the milk M, and flows smoothly downstream. This makes it possible to accelerate discharge of the auxiliary airflow AF2 that has attracted the hot air of the milk M. In addition, air stagnation does not easily occur on the downstream side of the guide portion 37. Therefore, it is possible to suppress the occurrence of dew condensation near the second inclined surface 37e. As a result, it is possible to maintain the liquid cooling device 10E in a clean state.

In the liquid cooling device 10E, when the time required for cooling the milk M to 45° C. in a case where the guide portion 37 was provided and the time required for cooling the milk M to 45° C. in a case where the guide portion 37 was not provided were compared, the time was approximately 1 minute and 10 seconds faster in the case where the guide portion 37 was provided. Therefore, the cooling effect of the milk M is increased by the guide portion 37. Consequently, the liquid cooling device 10E of the embodiment can quickly cool the milk M to an ideal temperature by efficiently generating a swirling flow in the inside of the milk preparing pot 4.

Here, as the main airflow AF1 flows from the upstream side towards the downstream side of the blowing channel 34, the flow speed is gradually reduced. As in the embodiment, the location where the guide portion 37 is provided is the region above the hole 33a that is disposed closest to the side of the upstream-side end portion 34d. Therefore, the guide portion 37 is capable of directly guiding the main airflow AF1 having a high flow speed as the auxiliary airflow AF2 into the milk preparing pot 4. Consequently, the auxiliary airflow AF2 that enters the milk preparing pot 4 has a high flow speed. Thus, the flow speed of the swirling flow that is generated in the inside of the milk preparing pot 4 is increased, as a result of which the milk M is efficiently cooled.

Although, in the embodiment, as shown in FIG. 8(B), the guide portion 37 is provided in the region above the hole portion 33a and in correspondence with the central portion of the hole portion 33a, the location of the guide portion 37 is not limited to this portion. That is, the guide portion 37 may be disposed in a region above the hole portion 33a and in correspondence with an upstream portion or a downstream portion of the hole 33a.

Although, in the embodiment, the guide portion 37 is provided in the region above the hole portion 33a on the side of the upstream-side end portion 34d of the blowing channel 34, the guide portion 37 may be provided in a region above the hole portion 33c on the side of the downstream-side end portion 34e.

### Sixth Embodiment

A sixth embodiment of the present invention has a structure in which the disposition of the guide portion 37 of the liquid cooling device 10E of the fifth embodiment is changed. Therefore, structures that are the same as those of the first to fifth embodiments are not described.

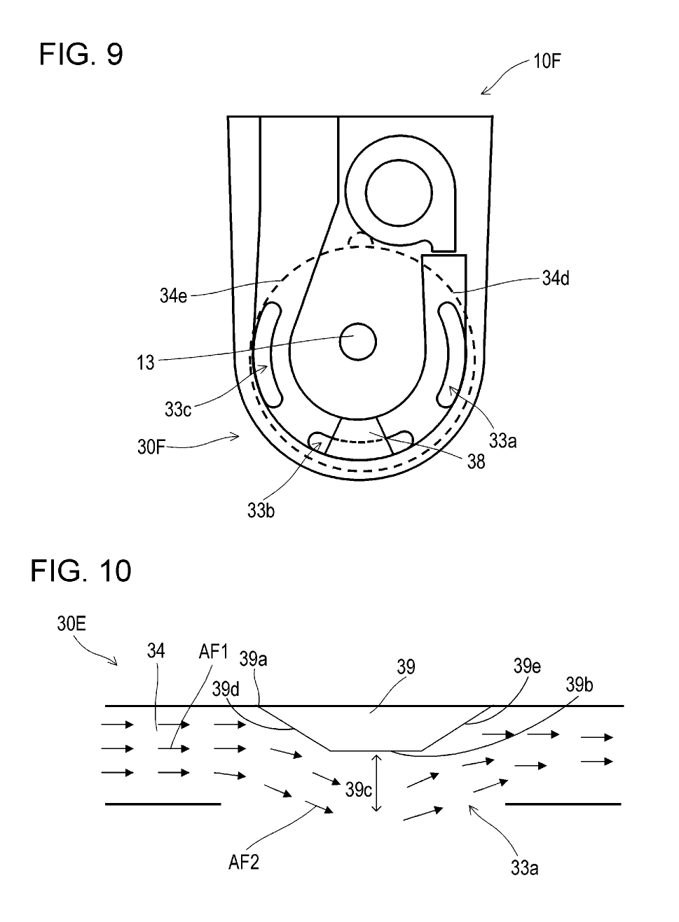

As shown in FIG. 9, a guide portion 38 of a liquid cooling device 10F of the embodiment is disposed in a region above a hole 33b (see FIG. 8(B)). The guide portion 37 is disposed in correspondence with a central portion of the region above the hole portion 33b.

As shown in FIG. 9, the shape of the guide portion 38 is the same as the shape of the guide portion 37 of the fifth embodiment. That is, an upper end portion 38a of the guide portion 38 is provided in contact with an upper surface of a blowing channel 34, and a protruding end 38b (see FIG. 8(B)) that protrudes from the upper surface to a lower surface (including an opposing lower surface 34a) of the blowing channel 34 is formed. A gap 38c for allowing a main airflow AF1 to pass therethrough is formed between the protruding end 38b and the lower surface of the blowing channel 34. The guide portion 38 includes a first inclined surface 38d and a second inclined surface 38e, and has sectional shape that is an inverted triangular shape.

Further, as shown in FIG. 9, the location where the guide portion 38 is provided is a front side of the liquid cooling device 10F, and is easily reachable by the hands of a user. Therefore, cleaning is easy to perform and the liquid cooling device 10F can be kept in a clean state.

Here, in the liquid cooling device 10F of the embodiment, when the time required for cooling the milk M to 45° C. in a case where the guide portion 38 was provided and the time required for cooling the milk M to 45° C. in a case where the guide portion 38 was not provided were compared, the time was approximately 1 minute faster in the case where the guide portion 38 was provided. Therefore, the cooling effect of the milk M is increased by the guide portion 38. Consequently, the liquid cooling device 10F of the embodiment can quickly cool the milk M to an ideal temperature by efficiently generating a swirling flow in the inside of a milk preparing pot 4.

### Seventh Embodiment

A guide portion 39 of a seventh embodiment of the present invention is formed with a shape that differs from the shape of the guide portion 37 of the fifth embodiment. Therefore, structures that are the same as those of the first to fifth embodiments are not described.

As shown in FIG. 10, the guide portion 39 of the seventh embodiment corresponds to the guide portion 37 having a lower end surface that is parallel to a lower surface of a blowing channel 34. That is, the guide portion 39 includes a horizontal surface 39b that is parallel to the lower surface of the blowing channel 34. Similarly to the guide portion 37 of the fifth embodiment, the guide portion 39 has a gap 39c, a first inclined surface 39d, and a second inclined surface 39e.

According to the guide portion 39, when a main airflow AF1 flows along the first inclined surface 39d, a part of the main airflow AF1 becomes an auxiliary airflow AF2, is guided into a milk preparing pot 4 from a hole portion 33a, and enters the milk preparing pot 4. Since the gap 39c becomes larger due to the horizontal surface 39b, a space that allows an airflow component of the main airflow AF1 that did not become the auxiliary airflow AF2 to flow can be sufficiently provided in the blowing channel 34. Therefore, the main airflow AF1 can flow smoothly through the blowing channel 34, and is moderately guided into the milk preparing pot 4. Consequently, air stagnation does not easily occur on a downstream side of the guide portion 39. Thus, it is possible to suppress the occurrence of dew condensation near the second inclined surface 39e.

### Eighth Embodiment

A guide portion 40 of an eighth embodiment of the present invention is formed with a shape that differs from the shape of the guide portion 37 of the fifth embodiment. Therefore, structures that are the same as those of the first to fifth embodiments are not described.

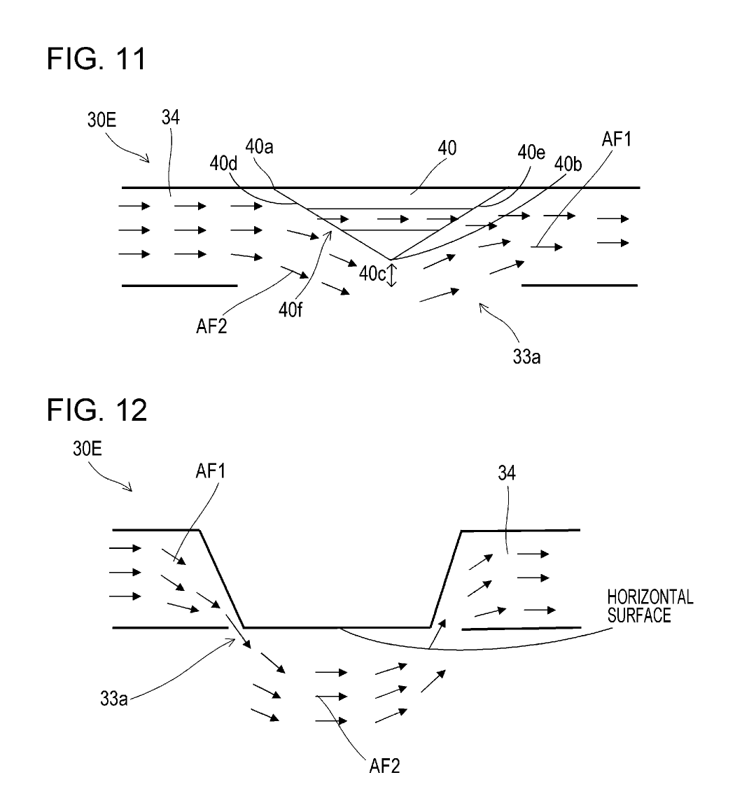

As shown in FIG. 11, similarly to the guide portion 37, the guide portion 40 of the eighth embodiment of the present invention includes a protruding end 40b, a gap 40c, a first inclined surface 40d, and a second inclined surface 40e, and a vertical section along a blowing channel 34 has an inverted triangular shape.

The guide portion 40 includes an airflow passage portion 40f that allows a part of a main airflow AF1 to pass therethrough from an upstream side towards a downstream side of the blowing channel 34. The airflow passage portion 40f may be a through hole, or a cutaway portion. This makes it possible for a part of the main airflow AF1 to pass through the airflow passage portion 40f and to flow smoothly through the blowing channel 34. Therefore, air stagnation does not easily occur on a downstream side of the guide portion 40. Thus, it is possible to suppress the occurrence of dew condensation near the second inclined surface 40e.

### Other Embodiments

(1) The fifth embodiment is an embodiment in which, regarding the positional relationship between the guide portion and a hole, the guide portion is disposed in the region above the hole portion and in correspondence with the upstream portion, the central portion, or the downstream portion of the hole portion. Similarly, in the sixth to eighth embodiments, the guide portion may be disposed in the region above a hole portion and in correspondence with the upstream portion or the downstream portion of the hole portion. If the main airflow AF1 is capable of entering the milk preparing pot 4 from the hole portion, the guide portion may be disposed slightly outwardly of the region above the hole portion.

(2) Although, in the fifth to eighth embodiments, the first inclined surface and the second inclined surface have planar shapes, they may be curved surfaces. For example, they may be curved with a predetermined curvature. Alternatively, they may be concave or convex surfaces.

(3) Although, in the fifth to eighth embodiments, regarding the shape of the guide portion, the first inclined surface and the second inclined surface are structural elements, the guide portion may have at least the first inclined surface. For example, a downstream-side surface of the guide portion may be a perpendicular surface.

(4) In the eighth embodiment, the protruding end 40b of the guide portion 40 may be a horizontal surface that is parallel to the lower surface of the blowing channel 34 as in the seventh embodiment.

(5) In the fifth to eighth embodiments, a gap is provided between the guide portion and a hole portion. In another embodiment, as shown in FIG. 12, a guide portion that blocks a blowing channel 34 with at least an upstream portion and a downstream portion of a hole portion 33 remaining may be provided at an upper surface of the blowing channel 34. In this case, the guide portion and the blowing channel 34 are integrally molded.

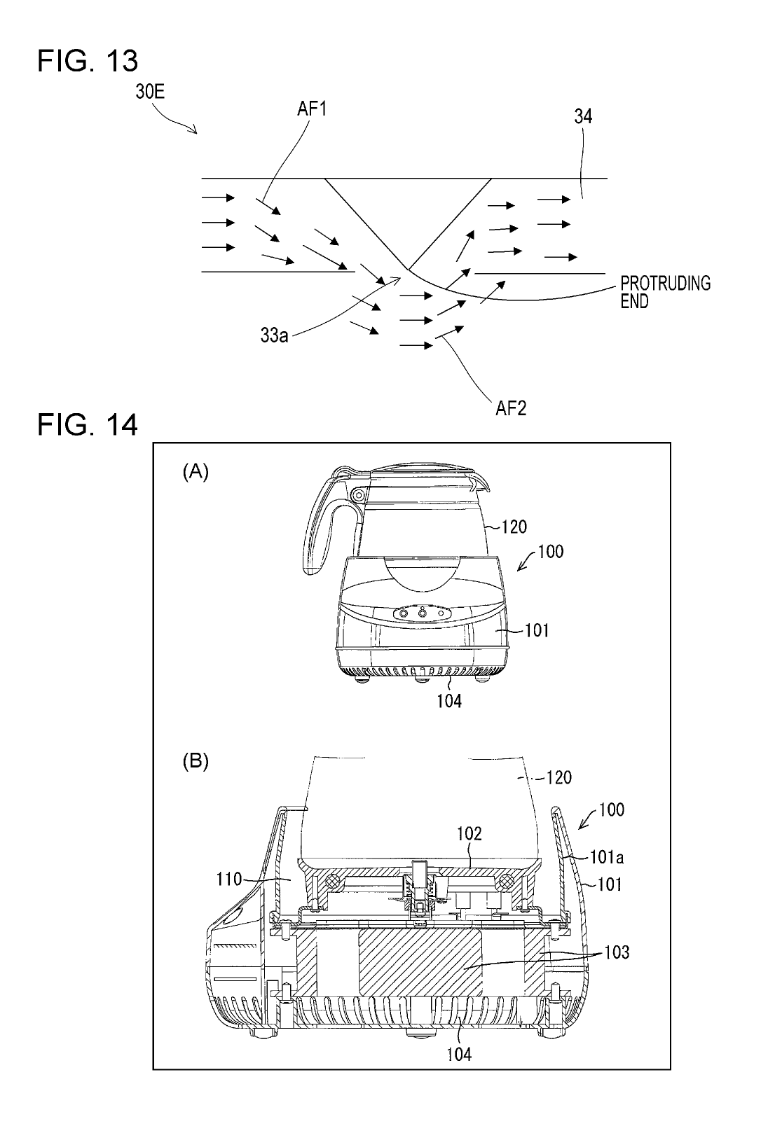

(6) Although, in the fifth to eighth embodiments, for example, a gap is provided between the protruding end of the guide portion and a hole, as shown in FIG. 13, a gap may be formed such that a protruding end of a guide portion contacts an opposing lower surface 34a.

(7) In the fifth to eighth embodiments, depending upon the size of the liquid cooling device, it is possible to change the distance between the protruding end (or the horizontal surface) of the guide portion and a hole to adjust the size of the gap.

(8) The fifth to eighth embodiments may be combined. This makes it possible to further increase the cooling efficiency of the milk M. A plurality of guide portions may be provided.

Accordingly, the present invention is applicable to a beverage forming device, such as a powdered formula preparing device and a liquid extracting device for, for example, coffee or tea, which are capable of obeying a suitable milk preparing method and capable of automatically preparing milk in a short time without using cooling water or the like. More specifically, the present invention is applicable to hygienic heating and cooling of a beverage, in particular, to the cooling of prepared high-temperature milk to a suitable temperature and to the making of milk containing a small amount of air bubbles.

### [Recapitulation]

The liquid cooling device 10A according to a first form of the present invention includes a liquid holding container (milk preparing pot 4) that has an open portion 4b; a container mounting part (placement portion 2a) on which the liquid holding container (milk preparing pot 4) is to be mounted; an air passage (blowing channel 34) that is located directly above the open portion 4b, at least a part of an outer periphery of the air passage extending along a peripheral edge of the open portion 4b; and an airflow generating unit (fan 32) that generates, within the air passage (blowing channel 34), an airflow flowing along the air passage (blowing channel 34). A hole portion 33 that communicates with the open portion 4b is provided in a lower surface of the air passage (blowing channel 34).

According to the above-described structure, the air passage is provided directly above the liquid holding container, and the hole portion 33 that communicates with the open portion 4b is provided in the lower surface of the air passage from the upstream-side end portion 34d to the downstream-side end portion 34e. Therefore, the airflow generating unit allows air exchange to be performed via the hole portion 33 between the main airflow AF1 that is generated in the inside of the liquid holding container and hot air in the inside of the liquid holding container. In addition, by the air exchange, the main airflow AF1 generates the auxiliary airflow AF2 that has branched off and flown into the liquid holding container from the hole portion 33. The auxiliary airflow AF2 is such that the flow speed of a horizontal component is maintained relatively high, and flows above the liquid surface of a liquid in the inside of the liquid holding container. According to the above-described structure, when, in the inside of the liquid holding container, the auxiliary airflow AF2 strikes the liquid surface of the liquid from the horizontal direction, the liquid is cooled.

Since the auxiliary airflow AF2 in the inside of the liquid holding container is such that the flow speed of a horizontal-direction airflow component that flows along the liquid surface of the liquid is relatively high, the auxiliary airflow AF2 strikes the entire liquid surface, instead of a part of the liquid surface. As a result, according to the above-described structure, it is possible to efficiently take away the heat from the entire liquid surface of the liquid and to efficiently cool the liquid.

In the liquid cooling device 10A according to a second form of the present invention, in the first form, it is desirable that a shape of the peripheral edge of the open portion 4b be a circular shape.

As in the above-described structure, when the shape of the peripheral edge of the open portion 4b is a circular shape, the blowing channel 34 extends along an arc shape of the peripheral edge of the open portion 4b with the center of the open portion 4b as a center. Therefore, a part of the shape of the air passage is a ring shape. Consequently, according to the above-described structure, the main airflow AF1 that flows in the air passage becomes a swirling flow, and centrifugal force is produced in the main airflow AF1.

Therefore, according to the above-described structure, even if foreign substances, such as dust, are contained in the main airflow AF1, the foreign substances flow along an outer-peripheral inner wall 34f on an outer peripheral side of the air passage due to the centrifugal force, and the entry of foreign substances into the liquid holding container from the hole portion 33 is suppressed.

Therefore, according to the above-described structure, it is possible to efficiently cool the liquid, and the amount of foreign substances, such as dust, that enter the liquid is small.

In the liquid cooling device 10A according to a third form of the present invention, in the first form or second form, it is desirable that a shape of a peripheral edge of the hole portion 33 be long in a direction of extension of the air passage (blowing channel 34).

According to the above-described structure, airflow exchange between the main airflow AF1 and the auxiliary airflow AF2 occurs easily, so that the liquid can be efficiently cooled.

In the liquid cooling device 10A according to a fourth form of the present invention, in any one of the first to third forms, it is desirable that the hole portion 33 be disposed in the lower surface of the air passage (blowing channel 34) from the upstream-side end portion 34d to the downstream-side end portion 34e of the air passage (blowing channel 34).

According to the above-described structure, one hole portion 33 is formed in the lower surface of the blowing channel 34. The hole portion 33 has the form of an opening portion in which an upstream-side-inlet-34b-side end extends up to the upstream-side end portion 34d, and a downstream-side-outlet-34c-side end extends up to the downstream-side end portion 34e. This increases the amount of auxiliary airflow AF2 that enters the milk preparing pot 4. Since one hole portion 33 is used, it is easy to mold the lower surface of the blowing channel 34.

In the liquid cooling device 10A according to a fifth form of the present invention, in any one of the first to fourth forms, it is desirable that a plurality of the hole portions 33 be provided.

According to the above-described structure, the main airflow AF1 that flows in the blowing channel 34 and that contains foreign substances, such as dust, and the auxiliary airflow AF2 that enters the milk preparing pot 4 are separately formed. As a result, according to the above-described structure, it is possible to suppress the entry of foreign substances, such as dust, into the milk M while efficiently cooling the milk M by using the auxiliary airflow AF2.

In the liquid cooling device 10A according to a sixth form of the present invention, in any one of the first to fifth forms, it is desirable that an outer-peripheral-side peripheral edge of the hole portion 33 be disposed along an inner periphery of the open portion 4b as viewed from a side of the air passage (blowing channel 34).

According to the above-described structure, the main airflow AF1 in the air passage enters the liquid holding container (milk preparing pot 4) via the hole portion 33 with the directivity of the flow being maintained without the flow being disturbed. The auxiliary airflow AF2 in the inside of the liquid holding container is discharged from the liquid holding container via the hole portion 33 and merges with the main airflow AF1 with the directivity of the flow being maintained without the flow being disturbed. Therefore, according to the above-described structure, efficient air-cooling can be realized.

In the liquid cooling device 10A according to a seventh form of the present invention, in any one of the first to sixth forms, it is desirable that a peripheral edge of the hole portion 33 be disposed apart from an outer-peripheral-side side wall (outer-peripheral inner wall 34f) of the air passage (blowing channel 34).

Foreign substances, such as dust, contained in the main airflow AF1 flow along the outer-peripheral inner wall 34f due to centrifugal force. Therefore, according to the above-described structure, since the peripheral edge of the hole portion 33 is disposed apart from the outer-peripheral inner wall 34f, the foreign substances, such as dust, are less likely to enter the milk preparing pot 4 from the hole portion 33. This further suppresses the entry of foreign substances, such as dust, into the liquid.

In the liquid cooling device 10A according to an eighth form of the present invention, in the seventh form, it is desirable that a plurality of the hole portions 33 be provided, and the peripheral edges of all of the hole portions 33 be disposed apart from the outer-peripheral-side side wall (outer-peripheral inner wall 34f) of the air passage (blowing channel 34).

According to the above-described structure, the entry of foreign substances, such as dust, into the liquid can be suppressed while efficiently cooling the liquid by using the plurality of hole portions 33.

In the liquid cooling device 10A according to a ninth form of the present invention, in any one of the first to eighth forms, a center position of the hole portion 33 may be positioned inwardly of a center position of the air passage (blowing channel 34) in a width direction.

According to the above-described structure, foreign substances, such as dust, that flow along the outer-peripheral inner wall 34f are further less likely to enter the liquid holding container from the hole portion 33, and the entry of foreign substances, such as dust, into the liquid is further suppressed.

In the liquid cooling device 10A according to a tenth form of the present invention, in the ninth form, it is desirable that a plurality of hole portions 33 be provided, and the center positions of all of the hole portions 33 be positioned inwardly of the center position of the air passage (blowing channel 34) in the width direction.

According to the above-described structure, the entry of foreign substances, such as dust, into the liquid can be suppressed while efficiently cooling the liquid by using the plurality of hole portions 33.

In the liquid cooling device 10B according to an eleventh form of the present invention, in any one of the first to tenth forms, a plurality of the hole portions 33 may be provided, and the plurality of hole portions 33 may be provided such that, from an upstream side of the airflow (main airflow AF1) that flows in the air passage (blowing channel 34) to a downstream side thereof, center positions of the hole portions 33 are gradually shifted towards an inner-peripheral-side side wall (inner-peripheral inner wall 34g) of the air passage (main airflow AF1).

Fine foreign substances, such as fine dust, contained in the main airflow AF1 in the blowing channel 34 flow along the outer-peripheral inner wall 34f of the air passage due to centrifugal force of the main airflow AF1 in the inside of the air passage. Here, according to the above-described structure, since the hole portions 33 are disposed such that the closer the hole portions 33 are to the downstream side, the further away the hole portions 33 are from the outer-peripheral inner wall 34f of the air passage, the probability of the foreign substances, such as dust, entering the milk preparing pot 4 via the hole portions 33 is considerably reduced. Therefore, it is possible to cool the liquid where the entry of foreign substances, such as dust, has been further suppressed.

In the liquid cooling device 10A according to a twelfth form of the present invention, in any one of the first to eleventh forms, it is desirable that a gap between the open portion 4b of the liquid holding container (milk preparing pot 4) and the lower surface of the air passage (blowing channel 34) be less than or equal to 5 mm.

According to the above-described structure, since the gap between the blowing channel 34 and the open portion 4b is very small, the possibility of entry of outside air is considerably suppressed. Therefore, the entry of foreign substances, such as dust, into the milk M is suppressed.

In the liquid cooling device 10C according to a thirteenth form of the present invention, in any one of the first to twelfth forms, it is desirable that a plurality of the hole portions 33 be provided, at least one of the hole portions (hole portion 33a) be provided with a first straightening plate (send-out straightening plate 36a) that forms an airflow (branch airflow AF3) from the air passage (blowing channel 34) towards the liquid holding container (milk preparing pot 4), and at least one different hole portion (hole portion 33b) where the first straightening plate (send-out straightening plate 36a) is not provided is provided with a second straightening plate (take-in straightening plate 36b) that forms an airflow (merging airflow AF4) from the liquid holding container (milk preparing pot 4) towards the air passage (blowing channel 34).

According to the above-described structure, the air in the inside of the air passage and the air in the inside of the liquid holding container are smoothly and efficiently exchanged. This causes the flow of the main airflow AF1 and the flow of the auxiliary airflow AF2 to have even better directivities, so that very efficient air-cooling can be realized.

In the liquid cooling device 10A according to a fourteenth form of the present invention, in any one of the first to thirteenth forms, it is desirable that, of the peripheral edge of the open portion 4b, the air passage (blowing channel 34) extend along a region of the peripheral edge extending 180 degrees or more with a center of the open portion 4b as a center.

By virtue of the above-described structure, wind that is sent into the blowing channel 34 from the fan 32 forms the main airflow AF1 that swirls horizontally in the inside of the blowing channel 34 and that has a high flow speed. In this case, the hole portion 33 is also similarly disposed 180 degrees or more with the center of the open portion 4b as a center from the upstream-side end portion of the blowing channel 34 to the downstream-side end portion thereof.

Therefore, the main airflow AF1 is branched in the inside of the milk preparing pot 4 via the hole portion 33, and forms the auxiliary airflow AF2, where the flow speed of the horizontal-direction component is maintained high, in the milk preparing pot 4. The auxiliary airflow AF2 becomes a swirling flow. The swirling flow of the auxiliary airflow that is formed in the inside of the milk preparing pot 4 and in which the speed of the horizontal-direction component is high attracts the hot air of the milk M while rotating along an inner wall of the milk preparing pot 4. Thereafter, the auxiliary airflow that has become warm air rises, passes through the hole portion 33 in the lower surface of the blowing channel 34, merges with the main airflow flowing in the inside of the blowing channel 34, and is discharged to the outside of the device body 2 from the downstream-side outlet 34c.

Therefore, the milk M is efficiently cooled. In addition, it is possible to minimize the amount of foreign substances, such as dust, that are trapped in the milk M without blowing wind perpendicularly to the liquid surface of the milk M.

In the liquid cooling device 10A according to a fifteenth form of the present invention, in any one of the first to fourteenth forms, the air passage (blowing channel 34) includes an air discharging portion (downstream-side outlet 34c) that is disposed at a terminal end portion on a downstream side of the airflow (main airflow AF1) which flows in the air passage (blowing channel 34), and that discharges air to outside.

In the liquid cooling device 10D according to a sixteenth form of the present invention, in any one of the first to fifteenth forms, the air passage (blowing channel 34) may be a circulation path 40 extending along the peripheral edge of the open portion 4b in an entirety thereof, and a part of the circulation path 40 may include an air discharging portion (downstream-side outlet 34c) that discharges a part of air to outside.

By virtue of the above-described structure, the circulation path 40 forms a channel that not only allows air sucked in from the air inlet portion 31 to be sent to the downstream-side outlet 34c, but also allows a part of the air to return again to the vicinity of an upstream-side inlet 34b.

Therefore, the hole portion 33 can be disposed 360° along the inner periphery of the milk preparing pot 4. Therefore, the total opening area of the hole portion 33 is increased, and a swirling flow in the horizontal direction is generated in both the inside of the blowing channel 34 and the inside of the milk preparing pot 4, so that heat exchange with the milk M can be efficiently performed.

In the liquid cooling device 10A according to a sixteenth form of the present invention, in any one of the first to fifteenth forms, it is desirable that an upstream-side inlet 34b of the air passage (blowing channel 34) be open in a tangential direction of a ring shape of the air passage.

According to the above-described structure, it is possible to efficiently generate the main airflow AF1, which is a swirling flow, in the inside of the air passage.

In the liquid cooling device 10E according to a seventeenth form of the present invention, it is desirable that a guide portion 37 that guides at least a part of the airflow into the liquid holding container (the milk preparing pot 4) from the hole portion 33a be provided at the air passage (the blowing channel 34).

By virtue of the above-described structure, the auxiliary airflow AF2 that has branched off from the main airflow AF1 can be positively guided into the milk preparing pot 4. Therefore, it is possible to quickly cool the milk M to an ideal temperature by efficiently generating a swirling flow in the inside of the milk preparing pot 4.

In the liquid cooling device 10E according to an eighteenth form of the present invention, in the seventeenth form, it is desirable that the guide portion 37 include a first inclined surface 37d formed on an upstream side thereof, and the first inclined surface 37d cause the airflow that flows towards the liquid holding container (the milk preparing pot 4) to be formed.

By virtue of the above-described structure, the auxiliary airflow AF2 that has branched off from the main airflow AF1 can be smoothly guided into the milk preparing pot 4 along the first inclined surface 37d.

In the liquid cooling device 10E according to a nineteenth form of the present invention, in the eighteenth form, it is desirable that the first inclined surface 37d have a shape that is inclined such that a distance between the first inclined surface 37d and the lower surface of the air passage (the blowing channel 34) gradually becomes smaller from an upstream side towards a downstream side.

By virtue of the above-described structure, it is possible to smoothly guide the main airflow AF1 into the milk preparing pot 4 along the first inclined surface 37d.

In the liquid cooling device 10E according to a twentieth form of the present invention, in any one of the seventeenth to nineteenth forms, it is desirable that a plurality of the hole portions 33a be provided in a direction of extension of the air passage (the blowing channel 34), and the guide portion 37 be disposed in a region above the hole portion 33a provided at a most upstream side in the air passage (the blowing channel 34).

By virtue of the above-described structure, a large amount of main airflow AF1 that has flown in from the fan 32 can be guided into the milk preparing pot 4 from the holes 33a. Therefore, it is possible to quickly cool the milk M to an ideal temperature by efficiently generating a swirling flow in the inside of the milk preparing pot 4.

In the liquid cooling device 10F according to a twenty-first form of the present invention, in any one of the seventeenth to twentieth forms, it is desirable that the air passage (the blowing channel 34) extend towards a front side of the device from a rear side of the device and be curved at the front side of the device and extend towards the rear side, a hole portion 33c be provided at a location on the front side of the device in the air passage (the blowing channel 34), and a guide portion 38 be disposed in a region above the hole portion 33c.

The above-described structure allows a user to easily clean the liquid cooling device 10F.

In the liquid cooling device 10E according to a twenty-second form of the present invention, in any one of the seventeenth to twenty-first forms, it is desirable that the guide portion 37 include a second inclined surface 37e on a downstream side thereof, the second inclined surface 37e being inclined such that a distance between the second inclined surface 37e and the lower surface of the air passage (the blowing channel 34) gradually becomes larger from an upstream side towards a downstream side.

By virtue of the above-described structure, since the auxiliary airflow AF2 in the inside of the milk preparing pot 4 easily flows along the second inclined surface 37e after passing through the hole 33, the auxiliary airflow AF2 easily merges with the main airflow AF1. Therefore, the main airflow AF1 can flow through the blowing channel 34 without stagnating on the downstream side of the guide portion 37.

In the liquid cooling device 10A according to a twenty-third form of the present invention, in any one of the seventeenth to twenty-second forms, it is desirable that the guide portion 37 be provided at an upper surface of the air passage (the blowing channel 34) and protrude from the upper surface towards the lower surface of the air passage (the blowing channel 34).

By virtue of the above-described structure, the main airflow AF1 flows smoothly downstream while being guided towards the upper surface of the blowing channel 34 along the second inclined surface 37e with a protruding end 37b of the guide portion 37 serving as a boundary.

In the liquid cooling device 10E according to a twenty-fourth form of the present invention, in any one of the seventeenth to twenty-third forms, it is desirable that a vertical sectional shape of the guide portion 37 along the air passage (the blowing channel 34) be an inverted triangular shape.

By virtue of the above-described structure, the guide portion 37 can smoothly guide the main airflow AF1 into the milk preparing pot 4 along the first inclined surface 37d.

In the liquid cooling device 10E according to a twenty-fifth form of the present invention, in any one of the seventeenth to twenty-third forms, it is desirable that a guide portion 41 include a surface 39b at a portion of a lower end thereof, the surface 39b being parallel to the lower surface of the air passage (the blowing channel 34).

By virtue of the above-described structure, since a gap 39c becomes larger, the main airflow AF1 can smoothly flow through the blowing channel 34.

In the liquid cooling device 10A according to a twenty-sixth form of the present invention, in any one of the seventeenth to twenty-fifth forms, it is desirable that a guide portion 42 include an airflow passage portion 40f that allows at least a part of the airflow to pass therethrough from an upstream side towards a downstream side of the air passage (the blowing channel 34).

By virtue of the above-described structure, a part of the main airflow AF1 can pass through the airflow passage portion 40f and smoothly flow through the blowing channel 34.

In any one of the first to twenty-sixth forms, a beverage forming device (powdered formula preparing device 1A) according to a twenty-seventh form of the present invention desirably includes any one of the liquid cooling devices 10A to 10F. By virtue of the above-described structure, it is possible to realize a beverage forming device that can efficiently cool a beverage, serving as a liquid, in the inside of the liquid holding container.

The present invention is not limited to the above-described embodiments, and may be variously changed within the scope of the claims. Embodiments that are obtained by combining as appropriate technological means disclosed in each of the different embodiments are also included within the technological scope of the present invention. Further, new technological features may be provided by combining the technological means disclosed in each of the embodiments.

### REFERENCE SIGNS LIST

1A powdered formula preparing device (beverage forming device)

2 device body

2a placement portion (container mounting part)

4 milk preparing pot (liquid holding container)

4a stirrer

4b open portion

10A˜10F liquid cooling device

30A˜30F cooling portion

31 air inlet portion

31a filter

32 fan (airflow generating unit)

33 hole portion

33a˜33c hole portion

34 blowing channel (air passage)

34a opposing lower surface

34b upstream-side inlet

34c downstream-side outlet

34f outer-peripheral inner wall

34g inner-peripheral inner wall

36a send-out straightening plate (first straightening plate)

36a1 first send-out straightening plate

36a2 second send-out straightening plate

36b take-in straightening plate (second straightening plate)

37 guide portion

37a upper end portion

37b protruding end

37c gap

37d first inclined surface

37e second inclined surface

39b horizontal surface

40f airflow passage portion

AF1 main airflow

AF2 auxiliary airflow

AF3 branch airflow

AF4 merging airflow

d gap

L liquid

M milk

PM powdered formula

TM thermistor

1. A liquid cooling device comprising:
a liquid holding container that has an open portion;
a container mounting part on which the liquid holding container is to be mounted;
an air passage that is located directly above the open portion, at least a part of an outer periphery of the air passage extending along a peripheral edge of the open portion; and
an airflow generating unit that generates, within the air passage, an airflow flowing along the air passage,
wherein a hole portion that communicates with the open portion is provided in a lower surface of the air passage.

2. The liquid cooling device according to claim 1, wherein a shape of the peripheral edge of the open portion is a circular shape.

3. The liquid cooling device according to claim 1, wherein a shape of a peripheral edge of the hole portion is long in a direction of extension of the air passage.

4. The liquid cooling device according to claim 1, wherein the hole portion is disposed in the lower surface of the air passage from an upstream-side end portion to a downstream-side end portion of the air passage.

5. The liquid cooling device according to claim 1, wherein a plurality of the hole portions are provided.

6. The liquid cooling device according to claim 1, wherein an outer-peripheral-side peripheral edge of the hole portion is disposed along an inner periphery of the open portion as viewed from a side of the air passage.

7. The liquid cooling device according to claim 1, wherein a peripheral edge of the hole portion is disposed apart from an outer-peripheral-side side wall of the air passage.

8. The liquid cooling device according to claim 7, wherein a plurality of the hole portions are provided, and the peripheral edges of all of the hole portions are disposed apart from the outer-peripheral-side side wall of the air passage.

9. The liquid cooling device according to claim 1, wherein a center position of the hole portion is positioned inwardly of a center position of the air passage in a width direction.

10. The liquid cooling device according to claim 9, wherein a plurality of the hole portions are provided, and the center positions of all of the hole portions are positioned inwardly of the center position of the air passage in the width direction.

11. The liquid cooling device according to claim 1, wherein a plurality of the hole portions are provided, and the plurality of hole portions are provided such that, from an upstream side of the airflow that flows in the air passage to a downstream side thereof, center positions of the hole portions are gradually shifted towards an inner-peripheral-side side wall of the air passage.

12. The liquid cooling device according to claim 1, wherein a gap between the open portion of the liquid holding container and the lower surface of the air passage is less than or equal to 5 mm.

13. The liquid cooling device according to claim 1, wherein a plurality of the hole portions are provided,
at least one of the hole portions is provided with a first straightening plate that forms an airflow from the air passage towards the liquid holding container, and
at least one different hole portion where the first straightening plate is not provided is provided with a second straightening plate that forms an airflow from the liquid holding container towards the air passage.

14. The liquid cooling device according to claim 1, wherein, of the peripheral edge of the open portion, the air passage extends along a region of the peripheral edge extending 180 degrees or more with a center of the open portion as a center.

15. The liquid cooling device according to claim 1, wherein the air passage includes an air discharging portion that is disposed at a terminal end portion on a downstream side of the airflow which flows in the air passage, and that discharges air to outside.

16. The liquid cooling device according to claim 1, wherein the air passage is a circulation path extending along the peripheral edge of the open portion in an entirety thereof, and a part of the circulation path includes an air discharging portion that discharges a part of air to be discharged to outside.

17. The liquid cooling device according to claim 1, wherein a guide portion that guides at least a part of the airflow into the liquid holding container from the hole portion is provided at the air passage.

18. The liquid cooling device according to claim 17, wherein the guide portion includes a first inclined surface formed on an upstream side thereof, and the first inclined surface causes the airflow that flows towards the liquid holding container to be formed.

19. The liquid cooling device according to claim 18, wherein the first inclined surface has a shape that is inclined such that a distance between the first inclined surface and the lower surface of the air passage gradually becomes smaller from an upstream side towards a downstream side.

20. The liquid cooling device according to claim 17, wherein a plurality of the hole portions are provided in a direction of extension of the air passage, and the guide portion is disposed in a region above the hole portion provided at a most upstream side in the air passage.

21. The liquid cooling device according to claim 17, wherein the air passage extends towards a front side of the device from a rear side of the device and is curved at the front side of the device and extends towards the rear side,
the hole portion is provided at a location on the front side of the device in the air passage, and the guide portion is disposed in a region above the hole portion.

22. The liquid cooling device according to claim 17, wherein the guide portion includes a second inclined surface on a downstream side thereof, the second inclined surface being inclined such that a distance between the second inclined surface and the lower surface of the air passage gradually becomes larger from an upstream side towards a downstream side.

23. The liquid cooling device according to claim 17, wherein the guide portion is provided at an upper surface of the air passage and protrudes from the upper surface towards the lower surface of the air passage.

24. The liquid cooling device according to claim 17, wherein a vertical sectional shape of the guide portion along the air passage is an inverted triangular shape.

25. The liquid cooling device according to claim 17, wherein the guide portion includes a surface at a portion of a lower end thereof, the surface being parallel to the lower surface of the air passage.

26. The liquid cooling device according to claim 17, wherein the guide portion includes an airflow passage portion that allows at least a part of the airflow to pass therethrough from an upstream side towards a downstream side of the air passage.

27. A beverage forming device comprising:
the liquid cooling device according to claim 1.
